(19) United States
(12) Patent Application Publication
(10) Pub. No.: US 2008/0022214 A1
(43) Pub. Date: Jan. 24, 2008

(54) Data transmitting apparatus facilitating operation to designate data-transmission destination, data-transmitting program embodied in computer readable medium, and data transmission method

(75) Inventor: Kyoko Nakamura, Toyonaka-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/711,109

(22) Filed: Feb. 27, 2007

(30) Foreign Application Priority Data
Jul. 22, 2006 (JP) 2006-200143

(51) Int. Cl. G06F 3/048

(52) U.S. Cl. 715/748

(57) ABSTRACT

A PC has: a transmission-destination definition data storing portion to store transmission-destination definition data defining a plurality pieces of transmission-destination information for transmitting data; an icon storing portion to store a plurality of icons of which display forms are different each other, the plurality of icons respectively corresponding to the plurality pieces of transmission-destination information; a display portion to display one of the plurality of icons; a transmitting portion to, when an instruction for the displayed icon is made while an instruction for data is made, transmit the data based on one of the plurality pieces of transmission-destination information, the one of the piece of transmission-destination information corresponding to the displayed icon for which the instruction is made; and a switching-instruction accepting portion to accept a switching instruction to switch the displayed icon with another icon among the plurality of icons.

This application is based on Japanese Patent Application No. 2006-200143 filed with Japan Patent Office on Jul. 22, 2006, the entire content of which is hereby incorporated by reference.

### BACKGROUND OF THE INVENTION

1. Field of the Invention

The present invention relates to a data transmitting apparatus, a data-transmitting program embodied in a computer readable medium, and a data transmission method. More specifically, the invention relates to a data transmitting apparatus facilitating the operation to designate data-transmission destination, a data-transmitting program embodied in a computer readable medium and facilitating the operation to designate data-transmission destination, and a data transmission method facilitating the operation to designate data-transmission destination.

2. Description of the Related Art

Conventionally, when data is transmitted from a computer or the like, the sender has been required to set various kinds of information concerning the recipient and the transmission destination. For example, when a document is transmitted by facsimile, the sender is required to set the facsimile number of the recipient. When an image scanned by a copier is transmitted by e-mail, the sender is required to set the e-mail address of the recipient. Also, for the FTP (File Transfer Protocol) transmission function and the SMB (Server Message Block) transmission function, with which copiers nowadays are equipped, setting of recipient information (the address of the FTP server and the PC's name) by the sender is required. In view of this, various kinds of information concerning the recipient and the transmission destination are stored in the address book in advance, thereby eliminating the trouble of inputting the information concerning the recipient and the transmission destination on every occasion of transmission.

Further, Japanese Patent Application Publication No. 8-307477 describes a transmission operation system by which data to be transmitted is designated and transmitted. This operation system has a registration means to register address information possessed by a plurality pieces of transmission means of different protocols on an each-transmission-destination basis, and a means to produce a transmission-destination cabinet for each of the transmission destinations. This functions to eliminate the ineffective input or choice of a destination address on each occasion of transmission, thereby facilitating the transmission operation. The transmission operation apparatus also has an instruction means to add an identifier to a file and instruct transmission of the file based on the identifier of the designated file. This functions to prevent the complicated transmission operation of inputting various kinds of communication data and to enable transmission by a single action.

However, the conventional transmission operation system is problematic in that the sender cannot easily see by what means among the plurality of transmission means of different protocols the transmission is made.

### SUMMARY OF THE INVENTION

The present invention has been accomplished in order to solve the above problems. It is an object of the present invention to provide a data transmitting apparatus that facilitates user's operation to set the transmission destination to which data is transmitted among a plurality of transmission destinations.

It is another object of the present invention to provide a data-transmitting program that is embodied in a computer readable medium and that facilitates user's operation to set the transmission destination to which data is transmitted among a plurality of transmission destinations.

It is another object of the present invention to provide a data transmission method that facilitates user's operation to set the transmission destination to which data is transmitted among a plurality of transmission destinations.

According to an aspect of the present invention, there is provided a data transmitting apparatus having: a transmission-destination definition data storing portion to store transmission-destination definition data defining a plurality pieces of transmission-destination information for transmitting data; an icon storing portion to store a plurality of icons of which display forms are different each other, the plurality of icons respectively corresponding to the plurality pieces of transmission-destination information defined in the transmission-destination definition data; a display portion to display one of the plurality of icons; a transmitting portion to, when an instruction for the displayed icon is made while an instruction for data is made, transmit the data based on a piece of transmission-destination information, corresponding to the icon for which the instruction is made, among the plurality pieces of transmission-destination information; and a switching-instruction accepting portion to accept a switching instruction to switch the displayed icon with another icon among the plurality of icons.

According to another aspect of the present invention, there is provided a data transmitting apparatus having: a transmission-destination definition data storing portion to store transmission-destination definition data defining a plurality pieces of transmission-destination information for transmitting data, each of the plurality pieces of transmission-destination information corresponding to one of a plurality pieces of user identification information for respectively identifying a plurality of users; an icon storing portion to store a plurality of icons each having a first display form and a second display form, the first display form of each icon being different from the other first display forms on the basis of the user identification information, the second display form being different from the other second display forms on the basis of the transmission-destination information; a display portion to display, among the plurality of icons, a plurality of icons having different first display forms and arbitrary second display forms; a transmitting portion to, when an instruction for one of the plurality of displayed icons is made while an instruction for data is made, transmit the data based on a piece of transmission-destination information, corresponding to the icon for which the instruction is made, among the plurality pieces of transmission-destination information; and a switching-instruction accepting portion to accept a switching instruction to switch each of the plurality of displayed icons with another icon, wherein in response to acceptance of the switching instruction, the display portion replaces the icon for which the switching instruction has been accepted and displays another icon having the same first display form as the first display form of the replaced icon and having a different second display form from the second display form of the replaced icon.

According to another aspect of the present invention, there is provided a data-transmitting program embodied in a computer readable medium, the data-transmitting program being executed by a computer storing: transmission-destination definition data defining a plurality pieces of transmission-destination information for transmitting data; and a plurality of icons respectively corresponding to the plurality pieces of transmission-destination information defined in the transmission-destination definition data, the plurality of icons of which display forms are different each other, the program causing the computer to execute processing having: displaying one of the plurality of icons: transmitting, when an instruction for one of the plurality of displayed icons is made while an instruction for data is made, data based on a piece of transmission-destination information, corresponding to the icon for which the instruction is made, among the plurality pieces of transmission-destination information; and accepting a switching instruction to switch the displayed icon with another icon among the plurality of icons.

According to another aspect of the present invention, there is provided a data-transmitting program embodied in a computer readable medium, the data-transmitting program being executed by a computer storing: transmission-destination definition data defining a plurality pieces of transmission-destination information for transmitting data, each of the plurality pieces of transmission-destination information corresponding to one of a plurality pieces of user identification information for respectively identifying a plurality of users; and a plurality of icons each having a first display form and a second display form, the first display form of each icon being different from the other first display forms on the basis of the user identification information, the second display form being different from the other second display forms on the basis of the transmission-destination information; the program causing the computer to execute processing including: displaying, among the plurality of icons, a plurality of icons having different first display forms and arbitrary second display forms; transmitting, when an instruction for one of the plurality of displayed icons is made while an instruction for data is made, the data based on a piece of transmission-destination information, corresponding to the icon for which the instruction is made, among the plurality pieces of transmission-destination information; accepting a switching instruction to switch each of the plurality of displayed icons with another icon; and replacing, in response to acceptance of the switching instruction, an icon for which the switching instruction has been accepted and displaying another icon having the same first display form as the first display form of the replaced icon and having a different second display form from the second display form of the replaced icon.

According to another aspect of the present invention, there is provided a data transmission method executed by a computer storing: transmission-destination definition data defining a plurality pieces of transmission-destination information for transmitting data; and a plurality of icons respectively corresponding to the plurality pieces of transmission-destination information defined in the transmission-destination definition data, the plurality of icons of which display forms are different each other, the data transmission method including: displaying one of the plurality of icons: transmitting, when an instruction for one of the plurality of displayed icons is made while an instruction for data is made, data based on a piece of transmission-destination information, corresponding to the icon for which the instruction is made, among the plurality pieces of transmission-destination information; and accepting a switching instruction to switch the displayed icon with another icon among the plurality of icons.

According to another aspect of the present invention, there is provided a data transmission method executed by a computer storing: transmission-destination definition data defining a plurality pieces of transmission-destination information for transmitting data, each of the plurality pieces of transmission-destination information corresponding to one of a plurality pieces of user identification information for respectively identifying a plurality of users; and a plurality of icons each having a first display form and a second display form, the first display form of each icon being different from the other first display forms on the basis of said user identification information, said second display form being different from the other second display forms on the basis of said transmission-destination information, the data transmission method comprising; displaying, among the plurality of icons, a plurality of icons having different first display forms and arbitrary second display forms; transmitting, when an instruction for one of the plurality of displayed icons is made while an instruction for data is made, the data based on a piece of transmission-destination information, corresponding to the icon for which the instruction is made, among the plurality pieces of transmission-destination information; accepting a switching instruction to switch each of the plurality of displayed icons with another icon; and replacing, in response to acceptance of the switching instruction, the icon for which the switching instruction has been accepted and displaying another icon having the same first display form as the first display form of the replaced icon and having a different second display form from the second display form of the replaced icon.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a print system according to an embodiment of the present invention.

FIG. 2 is a block diagram showing an example of the hardware structure of a PC.

FIG. 3 is a functional block diagram showing the outline of the function of an MFP.

FIG. 4 is a first functional block diagram showing the outline of the function of the CPU, mounted in the PC, together with data stored in HDD.

FIG. 5 is a first diagram showing an example of transmission-destination definition data.

FIG. 6 is a first diagram showing an example of a display-form definition table.

FIGS. 7A-7C are first diagrams showing examples of icons.

FIG. 8 is a first diagram showing an example of an operating screen.

FIG. 9 is a flow chart showing an example of the flow of an operation-receiving processing according to a first embodiment.

FIG. 10 is a first flow chart showing an example of the flow of a data-transmission processing.

FIG. 11 is a first flow chart showing an example of the flow of an icon-switching processing.

FIG. 12 is a second diagram showing an example of the transmission-destination definition data.

FIGS. 13A-13C are second diagrams showing examples of icons.

FIG. 14 is a second functional block diagram showing the outline of the function of the CPU, mounted in the PC, together with data stored in HDD according to a second embodiment.

FIG. 15 is a third diagram showing an example of the transmission-destination definition data.

FIG. 16 is a first diagram showing an example of a first display-form definition table.

FIG. 17 is a first diagram showing an example of a second display-form definition table.

FIG. 18 is a second diagram showing an example of the operating screen.

FIG. 19 is a flow chart showing an example of the flow of the operation-receiving processing according to a second embodiment.

FIG. 20 is a second flow chart showing an example of the flow of the data-transmission processing.

FIG. 21 is a second flow chart showing an example of the flow of the icon-switching processing.

FIG. 22 is a flow chart showing an example of the flow of the operation-receiving processing according to a modified example of the second embodiment.

FIG. 23 is a third flow chart showing an example of the flow of the icon-switching processing.

FIG. 24 is a third functional block diagram showing, together with data stored in HDD, the outline of the function of the CPU mounted in the PC 100 corresponding to the icon.

FIG. 25 is a second diagram showing an example of the first display-form definition table.

FIG. 26 is a second diagram showing an example of the second display-form definition table.

FIG. 27 is a flow chart showing an example of the flow of the operation-receiving processing according to a third embodiment.

FIG. 28 is a third flow chart showing an example of the flow of the data-transmission processing.

FIG. 29 is a fourth flow chart showing an example of the flow of the icon-switching processing.

FIG. 30 is a flow chart showing an example of the flow of the operation-receiving processing according to a modified example of the third embodiment.

FIG. 31 is a fifth flow chart showing an example of the flow of the icon-switching processing.

FIG. 32 is a diagram showing an example of the operating screen of the display portion of the MFP.

### DESCRIPTION OF THE PREFERRED EMBODIMENTS

Embodiments of the present invention will be described below referring to the drawings. In the following description, parts having like functions and names will be denoted with like numerals, and therefore the description thereof will not be repeated.

### First Embodiment

FIG. 1 is a schematic diagram of a print system according to an embodiment of the present invention. Referring to FIG. 1, a print system 1 includes a personal computer (hereinafter referred to as a PC) 100, and MFPs (Multi Functional Peripherals) 200, 201, and 202, respectively connected to a network 2.

The network 2 is a local area network (LAN), and the connection can be either by wire or radio. Also, the network 2 is not limited to a LAN and can be a wide area network (WAN) such as the Internet, or a network using the Public Switched Telephone Networks.

The PC 100 is a general computer and has installed therein a printer driver program to control the MFPs 200, 201, and 202. When the MFPs 200, 201, and 202 are of different kinds, the PC 100 has installed therein three kinds of printer driver programs to control the MFPs 200, 201, and 202. Also in the PC 100, a data-transmitting program, described later, is installed. By executing the data-transmitting program, the PC 100 functions as a data-transmitting apparatus.

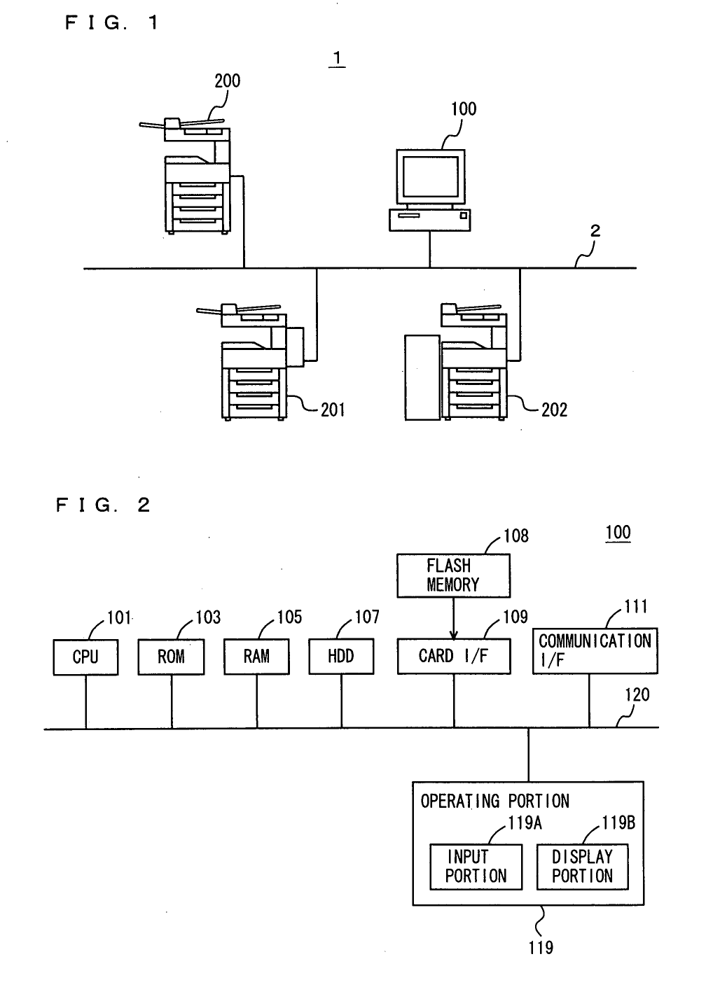

FIG. 2 is a block diagram showing an example of the hardware structure of the PC 100. Referring to FIG. 2, the PC 100 includes, connected to the network 2, a central processing unit (CPU) 101, a ROM (Read Only Memory) 103 to record therein a program and the like for the CPU 101 to execute, a RAM (Random Access Memory) 105 to load the executed program and store data in which a program is being executed, a hard disc drive (HDD) 107 serving as a mass storage, a card interface (I/F) 109 having a flash memory mounted therein, a communication I/F 111 to connect the CPU 101 to the network 2, and an operating portion 119 to serve as a user interface.

The CPU 101 loads in the RAM 105 a printer driver program recorded in the flash memory 108, which is mounted in the card I/F 109, and executes the printer driver program. The program executed by the CPU 101 is not limited to the printer driver program recorded in the flash memory 108; a printer driver program can be stored in the HDD 107 and loaded in the RAM 105 for execution. In this case, the printer driver program can be downloaded from another computer connected to the network 2 and stored in the HDD 107. The term program, as used herein, includes a source program, a compressed program, and an encoded program, as well as programs directly executable by the CPU 101.

The operating portion 119 includes an input portion 119A and a display portion 119B. The input portion 119A is an input device such as a keyboard and a mouse, which receives input of operations by the user of the PC 100. The display portion 119B is a display device such as a liquid crystal display device, an organic EL (Electro Luminescence) display panel, and a cathode-ray tube (CRT). It is possible to use a pointing device such as a touch panel for the input portion 119A.

The communication I/F 111 is a communication interface to connect the PC 100 to the network 2 or the PSTN. The PC 100 is communicable with the MFPs 200, 201, and 202 via the network 2, and communicable with, via the PSTN, other facsimiles connected thereto. While the example where the PC 100 is connected to the MFPs 200, 201, and 202 via the network 2 is described, direct connection using a serial interface or a parallel interface is also possible. For the communication I/F 111, an interface is used according to the form of connection of the PC 100 and each of the other MFPs 200, 201, and 202.

The MFPs 200, 201, and 202 each include a scanner to read text, an image-forming device to form an image on a recording medium such as a sheet of paper based on image data, and a facsimile. The MFPs 200, 201, and 202 are equipped with an image-reading function, a copying function, and a facsimile-transmitting-and-receiving function. While in this embodiment the MFPs 200, 201, and 202 are taken as an example, any other device can be used instead of the MFPs 200, 201, and 202 insofar as a function to process images is equipped, examples including a scanner, a printer, a copying machine, a facsimile, and a computer. The MFPs 200, 201, and 202 have the same structures and functions, and therefore the MFP 200 will be taken as an example here unless stated otherwise.

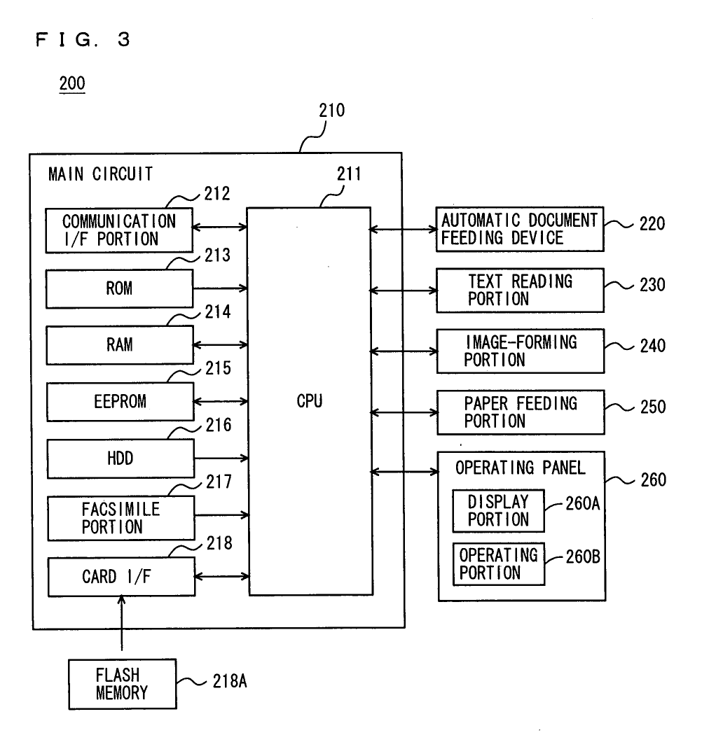

FIG. 3 is a functional block diagram showing the outline of the function of the MFP. Referring to FIG. 3, the MFP 200 includes a main circuit 210, a text reading portion 230 to read text, an automatic document feeding device 220 to convey document sheets to the text reading portion 230, an image-forming portion 240 to form an image on a sheet of paper or the like based on image data input from the text reading portion 230 that has read the text, a paper feeding portion 250 to supply sheets of paper to the image-forming portion 240, and an operating panel 260 serving as a user interface. The main circuit 210 includes a CPU 211, a communication interface (I/F) portion 212, a ROM 213, a RAM 214, an EEPROM (Electronically Erasable and Programmable ROM) 215, a hard disc drive (HDD) 216 serving as a mass storage, a facsimile portion 217, and a card interface (I/F) 218 having a flash memory 218A mounted therein. The CPU 211 is connected to the automatic document feeding device 220, the text reading portion 230, the image-forming portion 240, the paper feeding portion 250, and the operating panel 260, and controls the MFP 200 as a whole.

The ROM 213 stores programs executed by the CPU 211, or data necessary for execution of the programs. The RAM 214 is used as a work area for the CPU 211 to execute the programs. The RAM 214 temporarily stores read-out data (image data) transmitted continuously from the text reading portion 230.

The operating panel 260 includes a display portion 260A and an operating portion 260B. The display portion 260A is a display device such as an LCD and an organic ELD, and displays an instruction menu for a user, information concerning acquired image data, and the like. The operating portion 260B has a plurality of keys and receives input of data such as various instructions, characters, and numbers input by the user's operation and corresponding to the keys. The operating portion 260B further includes a touch panel provided on the display portion 260A.

The communication I/F portion 212 is an interface to connect the MFP 200 to the network 2. The CPU 211 communicates with the PC 100 via the communication I/F portion 212 to transmit and receive data.

The facsimile portion 217 is connected to the public switched telephone network (PSTN), and transmits facsimile data to the PSTN or receives facsimile data from the PSTN. Also, the facsimile portion 217 stores received facsimile data in the HDD 216 or outputs the received facsimile data to the image-forming portion 240. The image-forming portion 240 prints the facsimile data received by the facsimile portion 217 onto a sheet of paper. The facsimile portion 217 converts data stored in the HDD 216 into facsimile data and transmits it to a facsimile connected to the PSTN.

In the card I/F 218, the flash memory 218A is mounted. The CPU 211 can access the flash memory 218A via the card I/F 218. The CPU 211 loads in the RAM 214 a data-transmitting program recorded in the flash memory 218A, which is mounted in the card I/F 218, and executes the data-transmitting program. The program executed by the CPU 211 is not limited to the data-transmitting program recorded in the flash memory 218A. The data-transmitting program can be stored in the HDD 216 and loaded in the RAM 214 for execution. In this case, another computer connected to the network 2 can rewrite the data-transmitting program stored in the HDD 216 of the MFP 200, or additionally write a new data-transmitting program. Further, it is possible that the MFP 200 downloads a data-transmitting program from another computer connected to the network 2 and stores the data-transmitting program in the HDD 216. The term program, as used herein, includes a source program, a compressed program, and an encoded program, as well as programs directly executable by the CPU 211.

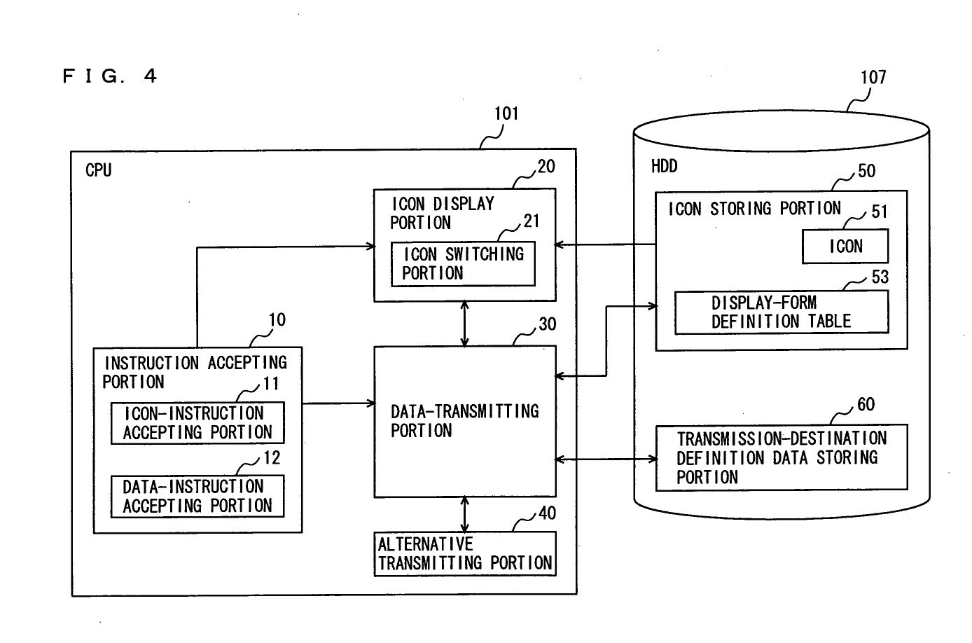

FIG. 4 is a first functional block diagram showing the outline of the function of the CPU 101, mounted in the PC 100, together with data stored in the HDD 107. The function of the CPU 101 when executing a data-transmitting program will be described here. Referring to FIG. 4, the HDD 107 includes an icon storing portion 50 and a transmission-destination definition data storing portion 60. The icon storing portion 50 includes a plurality of icons 51 having different display forms and a display-form definition table 52. The transmission-destination definition data storing portion 60 stores transmission-destination definition data that defines a plurality pieces of destination information for transmitting data. The icons 51, having different display forms, are identified by respective display forms. The icons 51, the display-form definition table 52, and the transmission-destination definition data are stored in the HDD 107 in advance. The display-form definition table 52 and the transmission-destination definition data are generated and amended by user's instructions that are input using the input portion 119A. The transmission-destination definition data can use, for example, an address book or the like produced in another program.

FIG. 5 is a first diagram shown in an example of transmission-destination definition data. Referring to FIG. 5, the transmission-destination definition data defines a piece of destination information for each destination to which data is transmitted. Here three destinations, a first destination to a third destination, are respectively associated with the facsimile number “03-3333-3333”, the e-mail address “xx001@aaa.com”, and the URL “¥¥goal¥ftp¥main”, for transmission by the FTP.

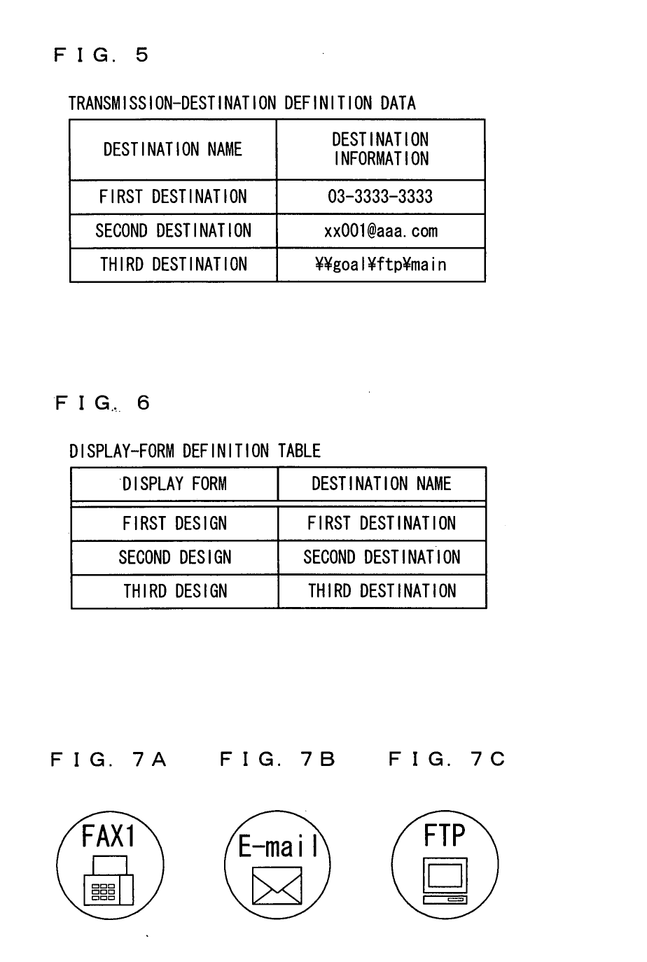

FIG. 6 is a first diagram showing an example of the display-form definition table. Referring to FIG. 6, the display-form definition table defines association of the display forms of the icons and destination names. The display form here is the design (shape) of an icon. The display-form definition table associates a first design with the first destination, a second design with the second destination, and a third design with the third destination.

FIGS. 7A-7C are first diagrams showing examples of the icons. FIG. 7A shows the icon corresponding to the first destination, FIG. 7B shows the icon corresponding to the second destination, and FIG. 7C shows the icon corresponding to the third destination. Referring to FIGS. 7A-7C, the three icons respectively corresponding to the first destination, the second destination, and the third destination differ in display form, which is the design here. Since in the transmission-destination definition data the first destination is associated with a facsimile number, the icon corresponding to the first destination has a facsimile-look design. Since in the transmission-destination definition data the second destination is associated with an e-mail address, the icon corresponding to the second destination has an e-mail-transmission-look design. Since in the transmission-destination definition data the third destination is associated with the FTP, the icon corresponding to the third destination has an FTP-transmission-look design.

Referring back to FIG. 4, the CPU 101 includes an instruction accepting portion 10 to accept input of user's instructions, an icon display portion 20 to choose among the plurality of icons stored in the HDD 107 and display a chosen icon, a data-transmitting portion 30 to transmit data, and an alternative transmitting portion 40.

The icon display portion 20 first refers to the display-form definition table 52, chooses one of the plurality of icons 51 stored in the HDD 107, and displays the chosen icon on the display portion 119B. It is assumed here that the icon display portion 20 chooses, first of all, the icon having the first design as the display form. The icon having the first design as the display form is associated with the destination information of the first destination by the display-form definition table and the transmission-destination definition data. This enables the user to discriminate between the pieces of destination information from the display form of the icon.

It is possible that the icon display portion 20 is adapted to display, in the vicinity of the icon, the piece of destination information associated with the display form of the icon by the display-form definition table and the transmission-destination definition data. By displaying a piece of destination information composed of characters in addition to the icon, the user can be informed of, using characters, which piece of destination information the icon is associated with. It is also possible that instead of displaying the piece of destination information in the vicinity of the icon all the time, the piece of destination information is displayed in the vicinity of the icon when the pointer points the icon on the display portion 119B.

The instruction accepting portion 10 accepts, from the input portion 119A, instructions input by a user using the input portion 119A. The instruction accepting portion 10 includes an icon-instruction accepting portion 11 and a data-instruction accepting portion 12. When a user operates the input portion 119A and makes an instruction for the icon displayed by the icon display portion 20 on the display portion 119B, then the icon-instruction accepting portion 11 accepts the instruction for the icon from the input portion 119A. It is possible that the instruction for the icon is made when the user, using the keyboard, makes an operation to choose the icon, or that the instruction for the icon is made when the user, using a pointing device, makes an operation to point the portion of the display portion 119B where the icon is displayed. Upon reception of the instruction for the icon, the instruction accepting portion 10 detects the display form for identifying the icon for which the instruction is made.

The data-instruction accepting portion 12 accepts instructions for data to be transmitted. For example, when an instruction to print data is made by an application program executed by the CPU 101, the data-instruction accepting portion 12 accepts the instruction for the data. When an instruction is made from the input portion 119A for data identification information for identifying data while the data identification information is being displayed on the display portion 119B, then the data-instruction accepting portion 12 accepts the instruction for the data from the input portion 119A. The data identification information is, for example, a file name attached to the data or an icon assigned to the data. Upon reception of the instruction for the data, the data-instruction accepting portion 12 acquires the data identification information of the data for which the instruction is made.

When the icon-instruction accepting portion 11 accepts an instruction for the icon while an instruction for the data is being received by the data-instruction accepting portion 12, then the instruction accepting portion 10 outputs a data-transmission instruction to the data-transmitting portion 30. The phraseology “while an instruction for the data is being received by the data-instruction accepting portion 12” is a period of time during which the instruction is valid. Specifically, the period of time is after the data-instruction accepting portion 12 accepts an instruction for the data and before the instruction accepting portion 10 accepts a next operation. For example, the period of time is after the user drugs the data identification information displayed on the display portion 119B and before the user drops the data identification information, or after the user clicks the data identification information and before a next operation comes. With the data identification information in the state of being displayed on the display portion 119B, when the user drugs the data identification information and then drops it in the icon, then the data-instruction accepting portion 12 accepts the instruction for the data by the drugging operation, and the icon-instruction accepting portion 11 accepts the instruction for the icon by the drugging operation. When the user clicks the icon immediately after clicking the data identification information, the data-instruction accepting portion 12 accepts the instruction for the data by the clicking operation of the data identification information, and the icon-instruction accepting portion 11 accepts the instruction for the icon by the clicking operation of the icon. The data-transmission instruction includes the data identification information detected by the data-instruction accepting portion 12 and the icon's display form detected by the icon-instruction accepting portion 11.

When the icon-instruction accepting portion 11 accepts an instruction for the icon while an instruction for the data is not being received by the data-instruction accepting portion 12, then the instruction accepting portion 10 outputs a switching instruction to the icon display portion 20. The switching instruction includes the icon's display form detected by the icon-instruction accepting portion 11.

The icon display portion 20 includes an icon switching portion 21. Upon input of a switching instruction from the instruction accepting portion 10, the icon switching portion 21 replaces the displayed icon and displays another icon having a display form different from the display form of the replaced icon. The icon display portion 20 displays, first of all, the icon having the first design as the display form, and when an instruction for the icon is made, the icon display portion 20 replaces the icon and displays the icon having the second design as the display form. When an instruction is made for the icon having the second design as the display form, the icon display portion 20 replaces the icon and displays the icon having the third design as the display form. Further, when an instruction is made for the icon having the third design as the display form, the icon display portion 20 replaces the icon and displays the icon having the first design as the display form. Since the icon display portion 20 displays an icon having a display form different from the display form of the previously displayed icon, the number of icons to be displayed is reduced.

Into the data-transmitting portion 30, a data transmission instruction is input from the instruction accepting portion 10. The data-transmitting portion 30 transmits data identified by the data identification information included in the data transmission instruction, to a piece of destination information identified by the display form included in the data transmission instruction. The data-transmitting portion 30 searches the display-form definition table and acquires a destination name associated with the display form included in the data transmission instruction. The data-transmitting portion 30 then extracts, from the transmission-destination definition data, a piece of destination information identified by the destination name. The data-transmitting portion 30 transmits, to the extracted piece of destination information, the data identified by the data identification information included in the data transmission instruction. When transmission of the data is not successful, the data-transmitting portion 30 outputs, to the alternative transmitting portion 40, an error signal indicating that data transmission has been unsuccessful. The error signal includes the data identification information and the destination name. It is also possible that the data-transmitting portion 30 is adapted to judge whether data transmission to the extracted piece of destination information is possible before the data is transmitted, and when data transmission is impossible, the data-transmitting portion 30 transmits an error signal to the alternative transmitting portion 40. For example, when the destination name is an FTP address, the data-transmitting portion 30 detects whether the device identified by the piece of destination information is active, and if so, judges that data transmission is possible, and if not, judges that data transmission is impossible.

Upon input of an error signal from the data-transmitting portion 30, the alternative transmitting portion 40 extracts, from the transmission-destination definition data, a piece of destination information associated with a destination name different from the destination name with which data transmission is unsuccessful. When there are a plurality of destination names different from the destination name with which data transmission is unsuccessful, the destination name to be extracted may be predetermined depending on the destination name with which data transmission is unsuccessful. For example, data is reversibly compressed when transmitted by e-mail and the FTP, and therefore there is no degradation in image quality. When transmitted by FAX, I-FAX, and SIP-FAX, however, data is irreversibly compressed according to each facsimile standard, and therefore there is large degradation in image quality. In view of this, when transmission to a piece of destination information associated with a destination name is either by e-mail or the FTP, the alternative transmitting portion 40 may be adapted to extract the other destination name. When transmission to a piece of destination information associated with a destination name is by one of FAX, I-FAX, and SIP-FAX, the alternative transmitting portion 40 may be adapted to extract one of the other destination names.

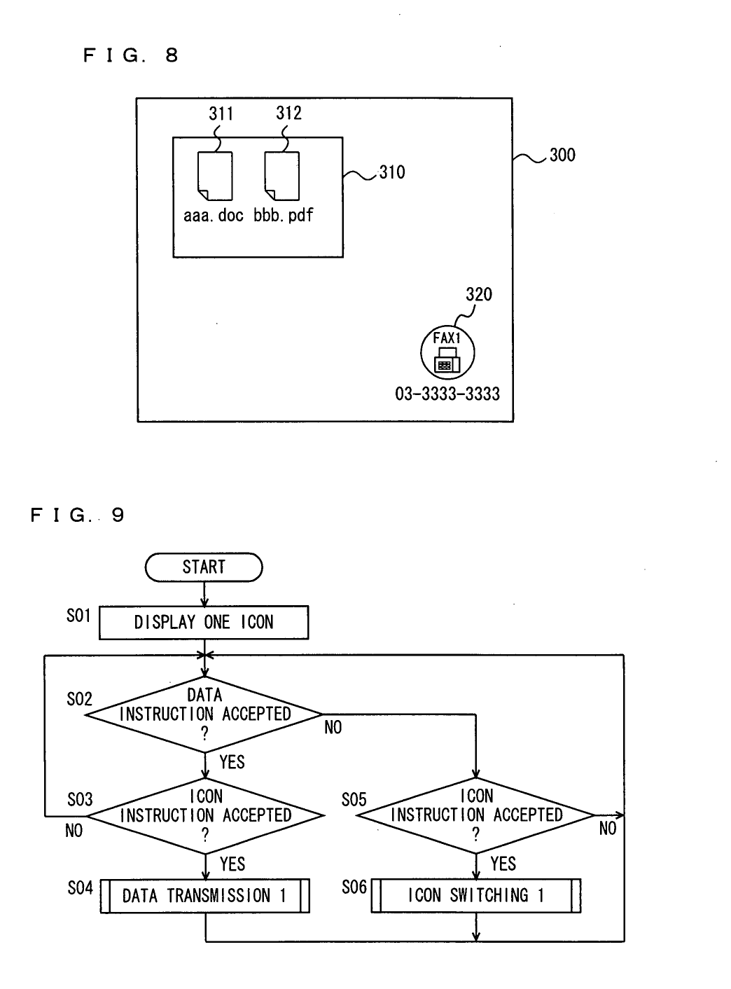

FIG. 8 is a first diagram showing an example of the operating screen. The operating screen is the screen displayed on the display portion 119B of the PC 100. Referring to FIG. 8, an operating screen 300 includes an icon 320 and a screen 310 to display pieces of data identification information 311 and 312. The pieces of data identification information 311 and 312 are thumbnails showing a down-sized version of each data. The screen 310 shows the file name “aaa.doc” below the piece of data identification information 311 and the file name “bbb.pdf” below the piece of data identification information 312. The icon 320 has the first design as the display form and corresponds to the piece of destination information of the destination name, “03-3333-3333”. The piece of destination information corresponding to the icon 320 is displayed below the icon 320.

When the user drugs, using a mouse, the piece of data identification information 311 and moves the pointer over the icon 320 and drops the piece of data identification information 311 there, then the data identified by the piece of data identification information 311 is transmitted by facsimile to the device assigned the facsimile number “03-3333-3333”. When the user clicks, using a mouse, the icon 320 once, the display form of the icon 320 is switched from the first design to the second design. When the icon 320 is clicked one more time, the display form of the icon 320 is switched from the second design to the third design.

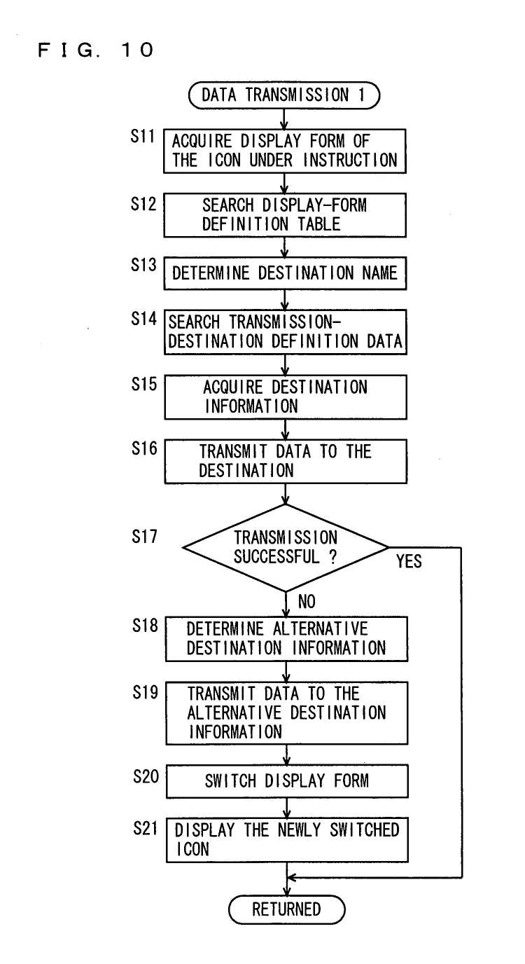

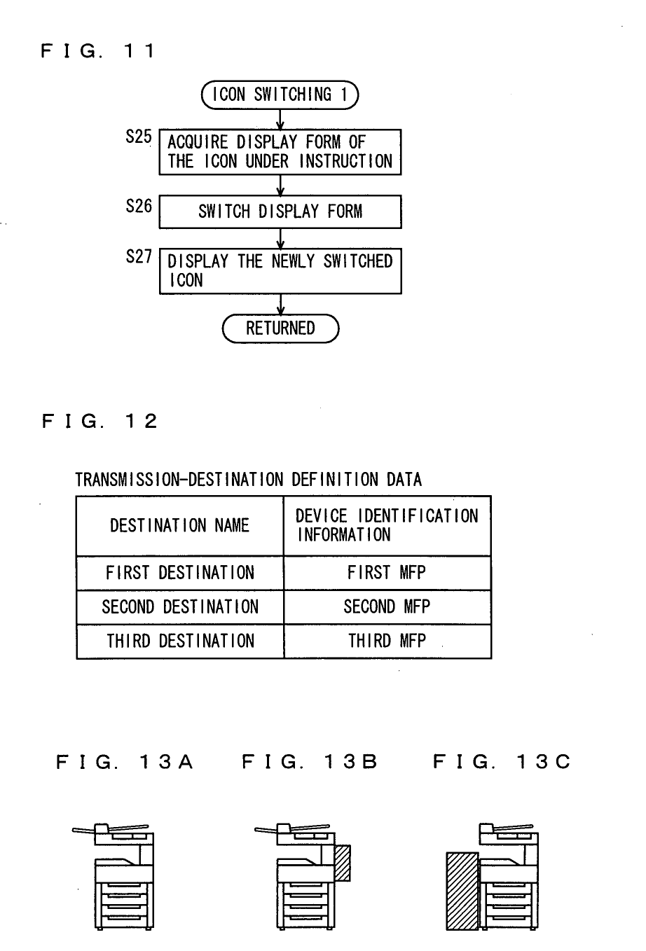

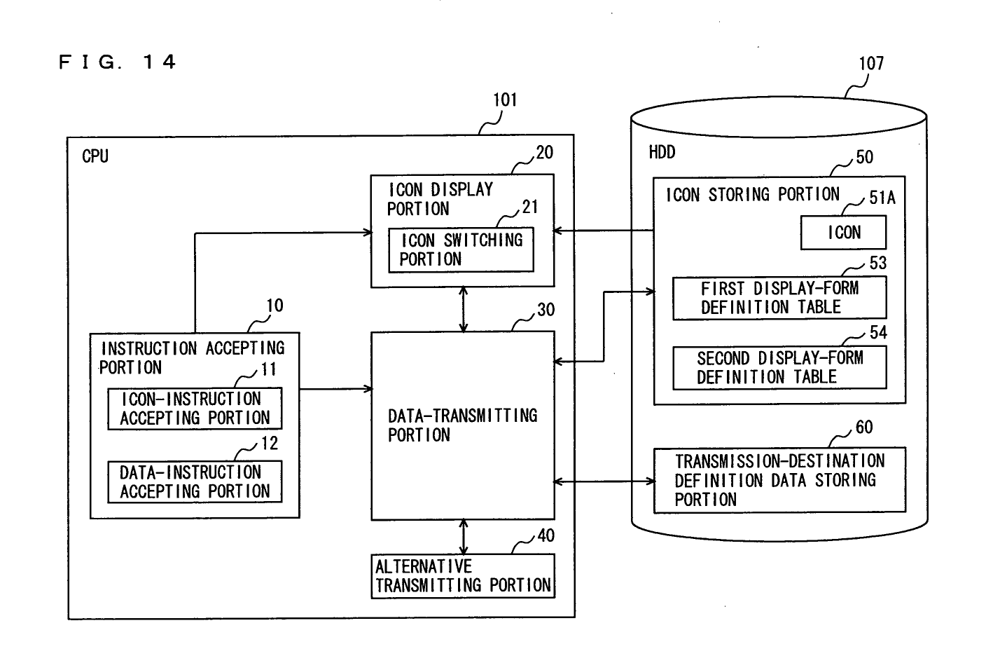

FIG. 9 is a flow chart showing an example of the flow of an operation-receiving processing according to a first embodiment. The operation-receiving processing is executed by the CPU 101 of the PC 100 by executing a data-transmitting program. Referring to FIG. 9, the CPU 101 chooses one of the plurality of icons 51 stored in the icon storing portion 50 of the HDD 107 and displays the chosen icon on the display portion 119B (step S01). It is assumed here that the icon having the first design as the display form is displayed. Next, the CPU 101 judges whether an instruction for data is accepted (step S02). When an instruction for data is accepted, the processing proceeds to step S03, and when an instruction for data is not accepted, the processing proceeds to step S05.

In step S03, the CPU 101 judges whether an instruction for the icon is accepted. When an instruction for the icon is received, the processing proceeds to step S04. When an instruction other than an instruction for the icon is accepted, the processing goes back to step S02. That is, when an instruction for the icon is received immediately after an instruction for data is received, i.e., when an instruction for the icon is received while an instruction for data is made, the data-transmitting processing in step S04 is executed. The data-transmitting processing will be described in detail later.

In step S05, the CPU 101 judges whether an instruction for the icon is accepted. When an instruction for the icon is received, the processing proceeds to step S06. When an instruction for the icon is not accepted, the processing goes back to step S02. That is, when an instruction for the icon is received while an instruction for data is not made, an icon switching processing in step S06 is executed. The icon switching processing will be described in detail later.

FIG. 10 is a first flow chart showing an example of the flow of a data-transmission processing. The data-transmission processing is executed in step S04 shown in FIG. 9. Referring to FIG. 10, the CPU 101 acquires the display form of the icon for which the instruction is made (step S11). Here the CPU 101 acquires the first design. In the next step S12, the CPU 101 searches the display-form definition table 52. Then, the CPU 101 determines the destination name “the first destination”, which is associated with the first design of the display form (step S13). In step S14, the CPU 101 searches the transmission-destination definition data. Then, the CPU 101 acquires the piece of destination information “03-3333-3333”, which is associated with the destination name “the first destination” (step S15). The CPU 101 then transmits the data for which the instruction is made in step S02 shown in FIG. 9, described above, to the destination identified by the piece of destination information acquired in step S15 (step S16). Specifically, the data for which the instruction is made in step S02 is transmitted to the facsimile assigned the piece of destination information “03-3333-3333”.

In the next step S17, the CPU 101 judges whether data transmission is successful. When data transmission is successful, the processing goes back to the operation-receiving processing. When data transmission is not successful, the processing proceeds to step S18. In step S18, the CPU 101 searches the transmission-destination definition data and determines a piece of destination information (alternative destination information) different from the piece of destination information acquired in step S15. It is assumed here that the piece of destination information “¥¥goal¥ftp¥main”, which is associated with the third destination, is determined as a piece of alternative destination information. Then, the CPU 101 transmits the data for which the instruction is made in step S02 to the piece of alternative destination information determined in step S18 (step S19). Specifically, the data for which the instruction is made in step S02 is transmitted by the FTP to the URL “¥¥goal¥ftp¥main”, which is the piece of alternative destination information. The CPU 101 then searches the display-form definition table and switches the display form of the icon to the third design corresponding to the piece of alternative destination information (step S20). In the next step S21, the CPU 101 displays, while replacing the icon for which the instruction is made, the icon having the third design as the display form and corresponding to the piece of alternative destination information on the display portion 119B. Then, the processing goes back to the operation-receiving processing. Thus, the icon for which the instruction is made in step S02 is replaced, and an icon having a display from different from the replaced icon is displayed. This enables it to inform the user that the data has been transmitted to a piece of destination information different from the piece of destination information associated with the icon for which the instruction is made.

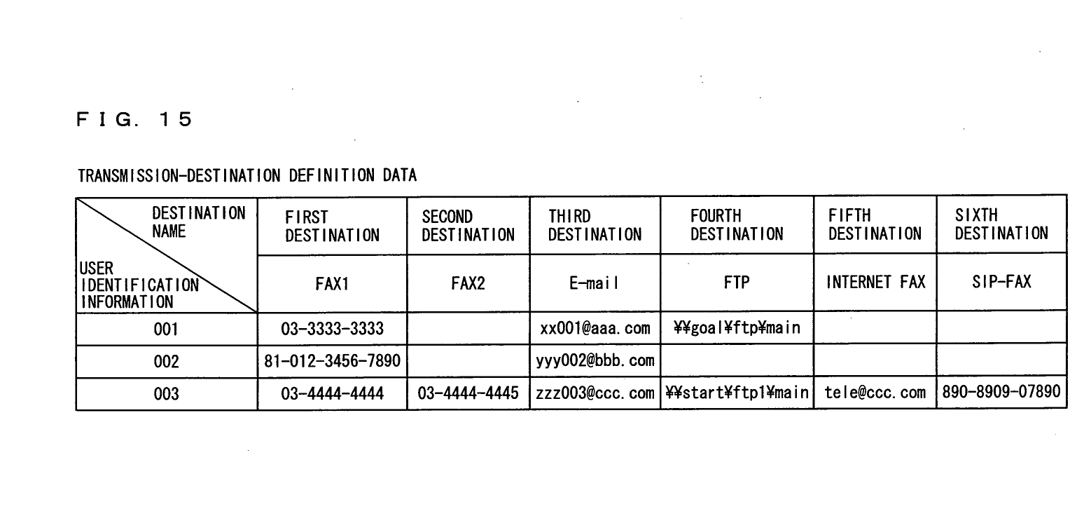

FIG. 11 is a first flow chart showing an example of the flow of the icon-switching processing. The icon-switching processing is executed in step S06 shown in FIG. 9. Referring to FIG. 11, the CPU 101 acquires the display form of the icon for which the instruction is made (step S25). Here the CPU 101 acquires the first design. Then, the CPU 101 switches the display form of the icon (step S26). Specifically, since the instruction is made for the icon having the first design, the display form is switched to a display form different from the first design. Here the case where the display form is switched from the first design to the second design, which is next to the first design, will be described. It is possible that the CPU 101 searches the display-form definition table and the transmission-destination definition data to extract the piece of destination information corresponding to the first design, which is the display form of the icon for which the instruction is made, and determines a display form corresponding to a piece of destination information providing the same degree of degradation of image quality as that provided by transmission to the piece of destination information corresponding to the first design.

In the next step 27, the CPU 101 displays, instead of the icon for which the instruction is made in step S05 shown in FIG. 9, the icon having the second design, which is the display form newly switched in step S26. Then, the processing goes back to the operation-receiving processing. That is, the icon for which the instruction is made is replaced, and an icon having a display form different from the replaced icon is displayed. This enables the user to display an icon corresponding to a different destination by the simple operation of icon instruction. Also, by looking at the newly switched icon, which has the second design as the display form, the user is able to recognize that the newly switched icon is associated with the piece of destination information “xx001@aaa.com”.

<Modified Example>

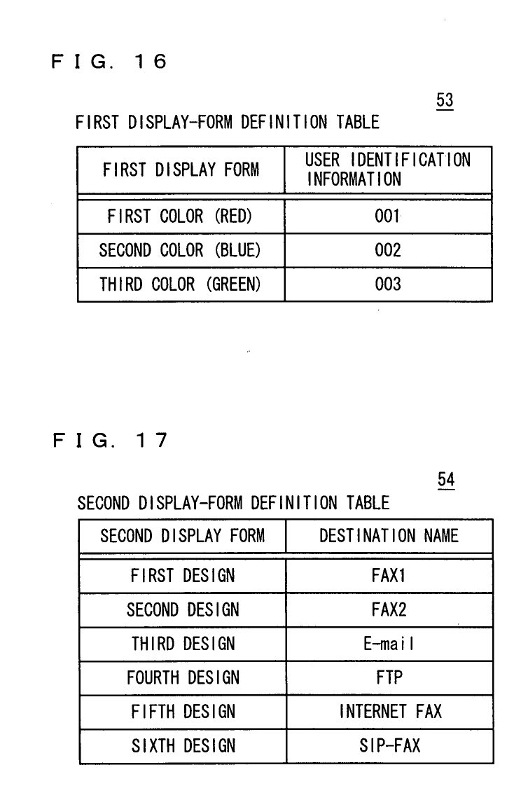

While in the above embodiment the transmission-destination definition data defines, as destination information, a facsimile number, a URL for FTP transmission, and the like, it is possible that the transmission-destination definition data defines device identification information for identifying the MFPs 200, 201, and 202, which form an image upon reception of data. FIG. 12 is a second diagram showing an example of the transmission-destination definition data. The pieces of device identification information of the MFPs 200, 201, and 202 are respectively named a first MFP, a second MFP, and a third MFP. Referring to FIG. 12, the transmission-destination definition data associates a first destination with the piece of device identification information of the MFP 200, a second destination with the piece of device identification information of the MFP 201, and a third destination with the piece of device identification information of the MFP 202. When an instruction for the icon having the first design as the display form is made while an instruction for data is made, the data is transmitted to the MFP 200. This enables the user to cause the MFP 200 to print the data by the simple operation of drugging and dropping the data. Also, when the user makes an instruction for the icon having the first design as the display form, the displayed icon is switched to an icon corresponding to the MFP 201 or MFP 202. This enables the user to, by this simple operation, select an MFP among the MFPs 200, 201, and 202 to print the data. It is possible that when an instruction for the icon having the first design as the display form is made while an instruction for data is made, a screen with which to set conditions for printing is displayed so that input of print conditions from the user is received. In this case, the screen with which to set print conditions is prepared in advance for the MFP 200, which corresponds to the icon for which the instruction is made. It is also possible to, when an instruction for the icon having the first design as the display form is made, execute a printer driver program stored in advance for the MFP 200, which corresponds to the icon for which the instruction is made.

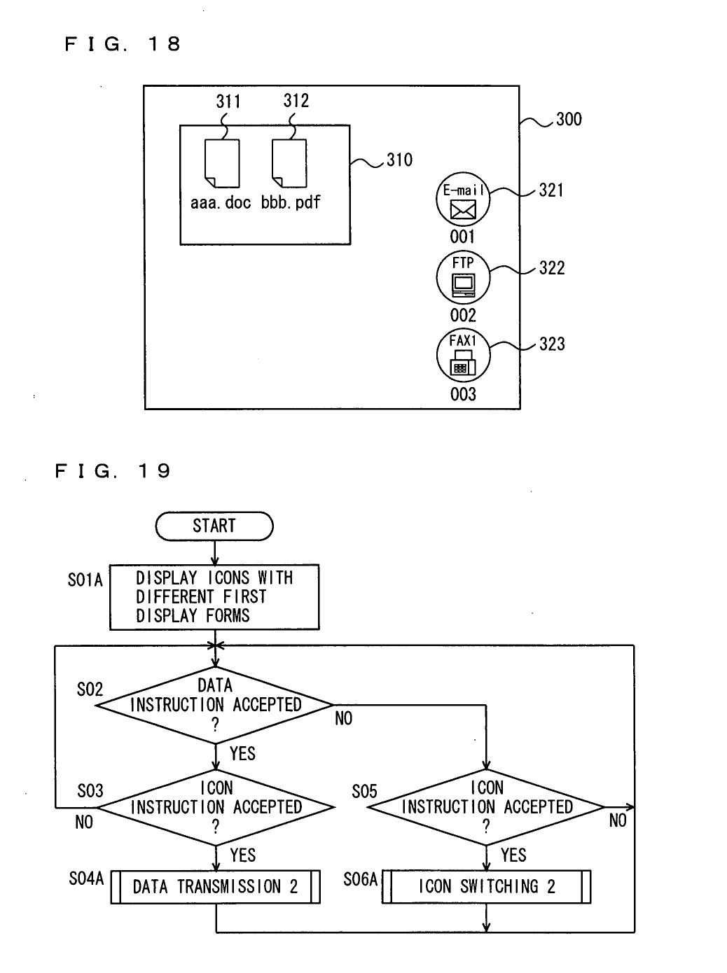

FIGS. 13A-13C are second diagrams showing examples of the icons.

FIG. 13A shows an icon corresponding to the MFP 200, which is the first MFP,

FIG. 13B shows an icon corresponding to the MFP 201, which is the second MFP, and FIG. 13C shows an icon corresponding to the MFP 202, which is the third MFP. When the MFPs 200, 201, and 202 have different functions, the respective icons preferably have designs that make each function distinguishable. In this example, the MFP 200 is not provided with a duplex printing unit for duplex printing and a postprocessing unit for sorting and the like, the MFP 201 is provided with a duplex printing unit and not provided with a postprocessing unit, and the MFP 202 is not provided with a duplex printing unit and provided with a postprocessing unit.

### Second Embodiment

A print system according to a second embodiment will be described, mainly on differences from the print system according to the first embodiment.

FIG. 14 is a second functional block diagram showing the outline of the function of the CPU 101, mounted in the PC 100, together with data stored in the HDD 107 according to the second embodiment. The function of the CPU 101 when executing a data-transmitting program will be described here. Referring to FIG. 14, the HDD 107 includes an icon storing portion 50 and a transmission-destination definition data storing portion 60. The icon storing portion 50 includes a plurality of icons 51A having different first display forms and different second display forms, a first display-form definition table 53, and a second display-form definition table 54. The transmission-destination definition data storing portion 60 stores transmission-destination definition data that defines a plurality pieces of destination information for each of users to whom data is transmitted. The icons 51A, having different first display forms and different second display forms, are identified by respective first display forms and second display forms. The icons 51A, the first display-form definition table 53, the second display-form definition table 54, and the transmission-destination definition data are stored in the HDD 107 in advance. The first display-form definition table 53, the second display-form definition table 54, and the transmission-destination definition data are generated and amended by user's instructions that are input using the input portion 119A. The transmission-destination definition can use, for example, an address book or the like produced in another program.

FIG. 15 is a third diagram showing an example of the transmission-destination definition data. Referring to FIG. 15, the transmission-destination definition data includes destination data for each piece of user identification information for identifying each of users to whom data is transmitted. The destination data includes a piece of user identification information and a plurality pieces of destination information. The pieces of destination information are classified by destination names. The destination names include “FAX 1” and “FAX 2” for identifying transmission by facsimile, “E-mail” for identifying transmission by e-mail, “FTP” for identifying file transfer, “Internet FAX” for identifying transmission by internet facsimile, and “SIP-FAX” for identifying transmission by SIP (Session Initiation Protocol) facsimile.

Here the example where the destination data includes three sets of destination data for three pieces of user identification information, 001-003, is described. The number of destination names to classify the destination information in the transmission-destination definition data can be arbitrarily determined insofar as a plurality of destination names are defined. Where, in the transmission-destination definition data, no piece of destination information exists for a destination name, the corresponding space is a blank. For example, in the destination data including user identification information 1, the spaces corresponding to the destination names FAX2, Internet FAX, and SIP-FAX are blanks.

FIG. 16 is a first diagram showing an example of the first display-form definition table. Referring to FIG. 16, the first display-form definition table defines association of the first display forms of the icons and user identification information. The first display form here is the color (hue) of an icon. The first display-form definition table associates a first color red with the user identification information “001”, a second color blue with the user identification information “002”, and a third color green with the user identification information “003”.

FIG. 17 is a first diagram showing an example of the second display-form definition table. Referring to FIG. 17, the second display-form definition table defines association of the second display forms of the icons and destination names. The display form here is the design of an icon. The second display-form definition table associates a first design with the destination name “FAX1”, a second design with the destination name “FAX2”, a third design with the destination name “E-mail”, a fourth design with the destination name “FTP”, a fifth design with the destination name “Internet FAX”, and a sixth design with the destination name “SIP-FAX”.

Referring back to FIG. 14, the CPU 101 includes an instruction accepting portion 10 to receive input of user's instructions, an icon display portion 20 to choose among the plurality of icons stored in the HDD 107 and display a chosen icon, a data-transmitting portion 30 to transmit data, and an alternative transmitting portion 40.

The icon display portion 20 first refers to the first display-form definition table 53, and chooses, among the plurality of icons 51A stored in the HDD 107, a plurality of icons having different first display forms, and displays the chosen icons on the display portion 119B. Since there are three kinds of first display forms, three icons are chosen. The second display forms of the three icons, chosen by the icon display portion 20, can be arbitrarily determined. It is assumed here that the icon display portion 20 chooses icons having the first design as the second display form. Thus, the icon display portion 20 chooses a first-design icon having the first color (red) as the first display form, a first-design icon having the second color (blue) as the first display form, and a first-design icon having the third color (green) as the first display form, and displays these icons. The first-design icon having the first color (red) as the first display form is associated with the destination name “FAX1” in the destination information including the user identification information “001”. The first-design icon having the second color (blue) as the first display form is associated with the destination name “FAX1” in the destination information including the user identification information “002”. The first-design icon having the third color (green) as the first display form is associated with the destination name “FAX1” in the destination information including the user identification information “003”. This enables the user to identify the destination users from the colors of the icons, and identify the destination names from the designs of the icons.

It is possible that the icon display portion 20 is adapted to display, in the vicinity of an icon, the piece of user identification information associated with the first display form of the icon in the first display-form definition table 53, or the destination name associated with the second display form of the icon in the second display-form definition table 54, or both user identification information and destination name. By displaying, in addition to the icon, a piece of user identification information composed of characters, a destination name composed of characters, or both user identification information and destination name, the user can be informed of, using characters, which user and destination the icon is associated with. It is also possible to display, in the vicinity of an icon, the associated destination information, which is identified by user identification information and a destination name. It is also possible that instead of displaying a piece of user identification information, a destination name, or destination information in the vicinity of an icon all the time, they are displayed in the vicinity of the icon when the pointer points the icon on the display portion 119B.

Upon reception of an instruction for an icon, the icon-instruction accepting portion 11 detects the first display form and the second display form for identifying the icon for which the instruction is made.

Upon input of a switching instruction from the instruction accepting portion 10, the icon switching portion 21 replaces the displayed icon and displays another icon having the same first display form as the first display form of the replaced icon and having a second display form different from the second display form of the replaced icon. The icon display portion 20 displays, first of all, the first-design icon having the first color (red) as the first display form, and when an instruction for the icon is made, the icon display portion 20 replaces the icon and displays a second-design icon having the first color (red) as the first display form. Since the icon display portion 20 displays an icon having the same first display form as the first display form of the previously displayed icon and having a second display form different from the second display form of the previously displayed icon, the number of icons to be displayed is reduced.

The icon switching portion 21 displays an icon having the same first display form as the first display form of the previously displayed icon and having a second display form different from the second display form of the previously displayed icon, on condition that the transmission-destination definition data defines destination information corresponding to such an icon. If an icon without destination information defined in the transmission-destination definition data were displayed, data could not be transmitted. Hence, the icon switching portion 21 does not display such an icon, thereby reducing the number of user's operations.

Into the data-transmitting portion 30, a data transmission instruction is input from the instruction accepting portion 10. The data-transmitting portion 30 transmits data identified by the data identification information included in the data transmission instruction, to a piece of destination information identified by the first display form and the second display form included in the data transmission instruction. The data-transmitting portion 30 searches the first display-form definition table and acquires a piece of user identification information associated with the first display form included in the data transmission instruction. Also, the data-transmitting portion 30 searches the second display-form definition table and acquires a destination name associated with the second display form included in the data transmission instruction. The data-transmitting portion 30 then extracts, from the transmission-destination definition data, a piece of destination information identified by the piece of user identification information and the destination name. The data-transmitting portion 30 transmits, to the extracted piece of destination information, the data identified by the data identification information included in the data transmission instruction. When transmission of the data is not successful, the data-transmitting portion 30 outputs, to the alternative transmitting portion 40, an error signal indicating that data transmission has been unsuccessful. The error signal includes the data identification information, the piece of user identification information, and the destination name. It is also possible that the data-transmitting portion 30 is adapted to judge whether data transmission to the extracted piece of destination information is possible before the data is transmitted, and when data transmission is impossible, the data-transmitting portion 30 transmits an error signal to the alternative transmitting portion 40. For example, when the destination name is an FTP address, the data-transmitting portion 30 detects whether the device identified by the piece of destination information is active, and if so, judges that data transmission is possible, and if not, judges that data transmission is impossible.

FIG. 18 is a second diagram showing an example of the operating screen. The operating screen is the screen displayed on the display portion 119B of the PC 100. Referring to FIG. 18, an operating screen 300 includes icons 321, 322, and 333, and a screen 310 to display pieces of data identification information 311 and 312. The pieces of data identification information 311 and 312 are thumbnails showing a down-sized version of each data. The screen 310 shows the file name “aaa.doc” below the piece of data identification information 311 and the file name “bbb.pdf” below the piece of data identification information 312.

The icon 321 has the first color (red) as the first display form and the third design as the second display form, respectively corresponding to the user identification information “001” and the destination name “E-mail”. The user identification information “001” is displayed below the icon 321. The icon 322 has the second color (blue) as the first display form and the fourth design as the second display form, respectively corresponding to the user identification information “002” and the destination name “FTP”. The user identification information “002” is displayed below the icon 322. The icon 323 has the third color (green) as the first display form and the first design as the second display form, respectively corresponding to the user identification information “003” and the destination name “FAX1”. The user identification information “003” is displayed below the icon 323.

For example, when the user drugs, using a mouse, the piece of data identification information 311 and moves the pointer over the icon 321 and drops the piece of data identification information 311 there, then an electronic mail including the data identified by the piece of data identification information 311 and setting the e-mail address “xx001@aaa.com” as the transmission destination is prepared and transmitted.

FIG. 19 is a flow chart showing an example of the flow of the operation-receiving processing according to the second embodiment. The operation-receiving processing is executed by the CPU 101 of the PC 100 by executing a data-transmitting program. Referring to FIG. 19, the operation-receiving processing differs from the operation-receiving processing shown in FIG. 9 in steps S01A, S04A, and S06A. The CPU 101 refers to the first display-form definition table 53 and chooses, among the plurality of icons 51A stored in the HDD 107, a plurality of icons having different first display forms, and displays the chosen icons on the display portion 119B (step S01A). Since there are three kinds of first display forms, three icons are chosen.

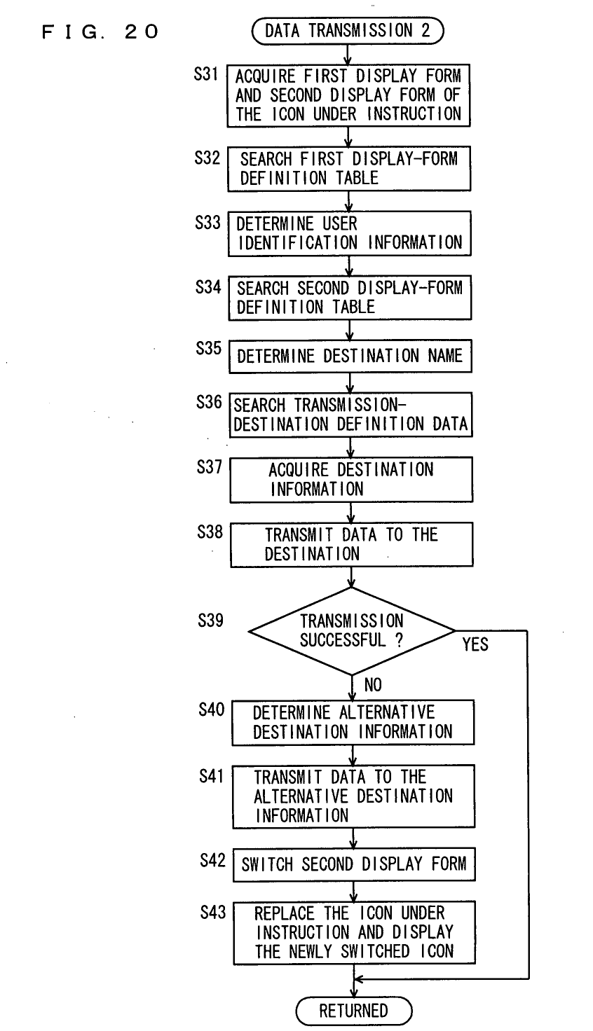

FIG. 20 is a second flow chart showing an example of the flow of the data-transmission processing. The data-transmission processing is executed in step S04A shown in FIG. 19. Referring to FIG. 20, the CPU 101 acquires the first display form and the second display form of the icon for which the instruction is made in step S02 shown in FIG. 19 (step S31). Here the example where the icon for which the instruction is made has the first color (red) as the first display form and the third design as the second display form will be described.

In next step S32, the CPU 101 searches the first display-form definition table 53 and determines on the user identification information “001”, which is associated with the first color of the first display form (step S33). In step S34, the CPU 101 searches the second display-form definition table 54 and determines on the destination name “E-mail”, which is associated with the third design of the second display form (step S35).

In the next step S36, the CPU 101 searches the transmission-destination definition data and acquires the piece of destination information “xx001@aaa.com”, which is identified by the user identification information “001”, determined in step S33, and by the destination name “E-mail”, determined in step S35 (step S37). Next, the CPU 101 transmits the data for which the instruction is made in step S02 shown in FIG. 19, to the piece of destination information acquired in step S37 (step S38). Specifically, an electronic mail including the data for which the instruction is made and setting the e-mail address “xx001@aaa.com” as the transmission destination is prepared and transmitted to an electronic mail server via the communication I/F 111.

In the next step S39, the CPU 101 judges whether data transmission is successful. When data transmission is successful, the processing goes back to the operation-receiving processing. When data transmission is not successful, the processing proceeds to step S40. In step S40, the CPU 101 searches the transmission-destination definition data and determines a piece of destination information (alternative destination information) different from the piece of destination information acquired in step S37. It is assumed here that the FTP destination name “¥¥goal¥ftp¥main” is determined. Then, the CPU 101 transmits the data for which the instruction is made to the piece of alternative destination information determined in step S40 (step S41). Specifically, the data for which the instruction is made is transmitted by the FTP to the URL “¥¥goal¥ftp¥main”. The CPU 101 then switches the second display form to the fourth design, which corresponds to the piece of alternative destination information (step S42). Then, the processing proceeds to step S43. In step S43, the CPU 101 replaces the icon for which the instruction is made in step S03 shown in FIG. 19 and displays the icon having the first display form acquired in step S31 and the second display form newly switched in step S42. Then, the processing goes back to the operation-receiving processing. That is, the icon for which the instruction is made is replaced, and an icon having the same first display form as the first display form of the replaced icon and having a second display form different from the second display form of the replaced icon is displayed. In other words, only the second display form of the icon for which the instruction is made changes. Here, in place of the icon having the first color (red) as the first display form and having the third design as the second display form, the icon having the first color (red) as the first display form and having the fourth design as the second display form is displayed. This enables it to inform the user that the data has been transmitted to a piece of destination information different from the piece of destination information associated with the icon for which the instruction is made, and inform the user of the piece of transmission-destination information to which the data has been transmitted. In this case, it is possible to alarm the user by displaying the icon in an unusual manner such as with flashing.

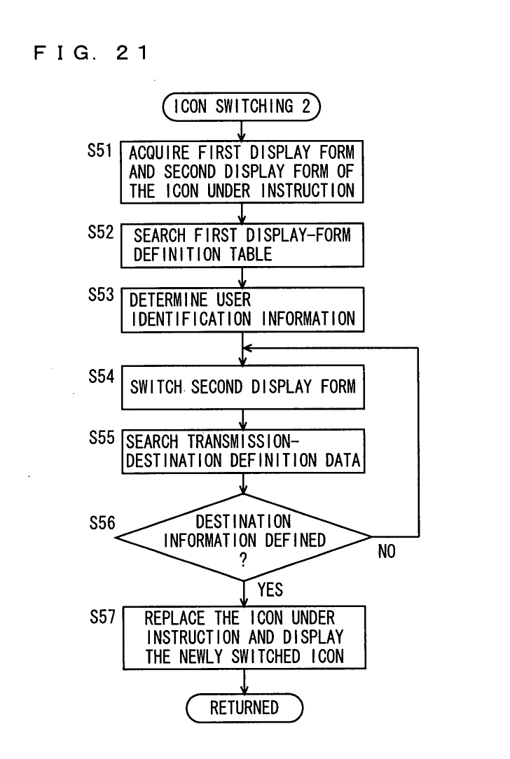

FIG. 21 is a second flow chart showing an example of the flow of the icon-switching processing. The icon-switching processing is executed in step S06A shown in FIG. 19. Referring to FIG. 21, steps S51 to S53 are the same as steps S31 to S33 shown in FIG. 20, and therefore description thereof will not be repeated. In step S54, the CPU 101 switches the second display form acquired in step S51. Specifically, since the instruction is made for the icon having the third design as the second display form, the second display form is switched to a second display form different from the third design. Here the case where the second display form is switched from the third design to the fourth design, which is next to the third design, will be described. It is possible that the CPU 101 searches the second display-form definition table to extract the piece of destination information corresponding to the third design, and determines a second display form corresponding to a piece of destination information providing the same degree of degradation of image quality as that provided by transmission to the piece of destination information corresponding to the third design.

In the next step S55, the CPU 101 searches the transmission-destination definition data. As a result of the search, the CPU 101 judges whether the destination information including the piece of user identification information determined in step S53 defines the piece of destination information corresponding to the destination name identified by association of the second display form newly switched in step S54 and the second display-form definition table (step S56). When such a piece of destination information is defined in the transmission-destination definition data, the processing proceeds to step S57. When not, the processing goes back to step S54.

In step S57, the CPU 101 displays, instead of the icon for which the instruction is made, the icon having the first display form acquired in step 51 and having the second display form newly switched in step 54. Then, the processing goes back to the operation-receiving processing. That is, the icon for which the instruction is made is replaced, and an icon having the same first display form as the first display form of the replaced icon and having a second display form different from the second display form of the replaced icon is displayed. In other words, only the second display form of the icon for which the instruction is made changes. Here, in place of the icon having the first color (red) as the first display form and having the third design as the second display form, the icon having the first color (red) as the first display form and having the fourth design as the second display form is displayed. By looking at the icon having the first color (red) as the first display form and having the fourth design as the second display form, the user is able to recognize that the new icon is associated with the FTP destination information assigned to the user having the user identification information “001”.

<Modified Example>

While in the second embodiment a plurality of icons having different first display forms are displayed, in this modified example a single icon is displayed. In this case, the icon-instruction accepting portion 11 accepts a first switching instruction to switch only the second display form of the displayed icon and a second switching instruction to switch only the first display form of the displayed icon. When the icon-instruction accepting portion 11 accepts a first switching instruction, the icon switching portion 21 replaces the displayed icon and displays an icon having the same first display form as the first display form of the replaced icon and having a second display form different from the second display form of the replaced icon. When the icon-instruction accepting portion 11 receives a second switching instruction, the icon switching portion 21 replaces the displayed icon and displays an icon having a first display form different from the first display form of the replaced icon and having the same second display form as the second display form of the replaced icon. For example, the first switching instruction is executed by clicking the mouse, and the second switching instruction is executed by clicking the mouse while pressing down the shift key.

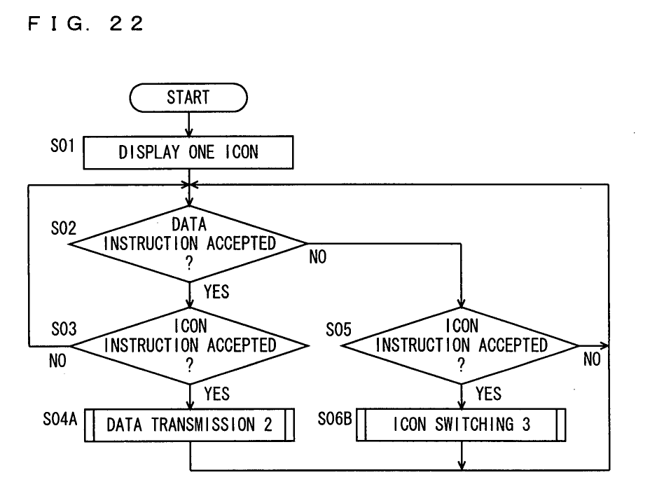

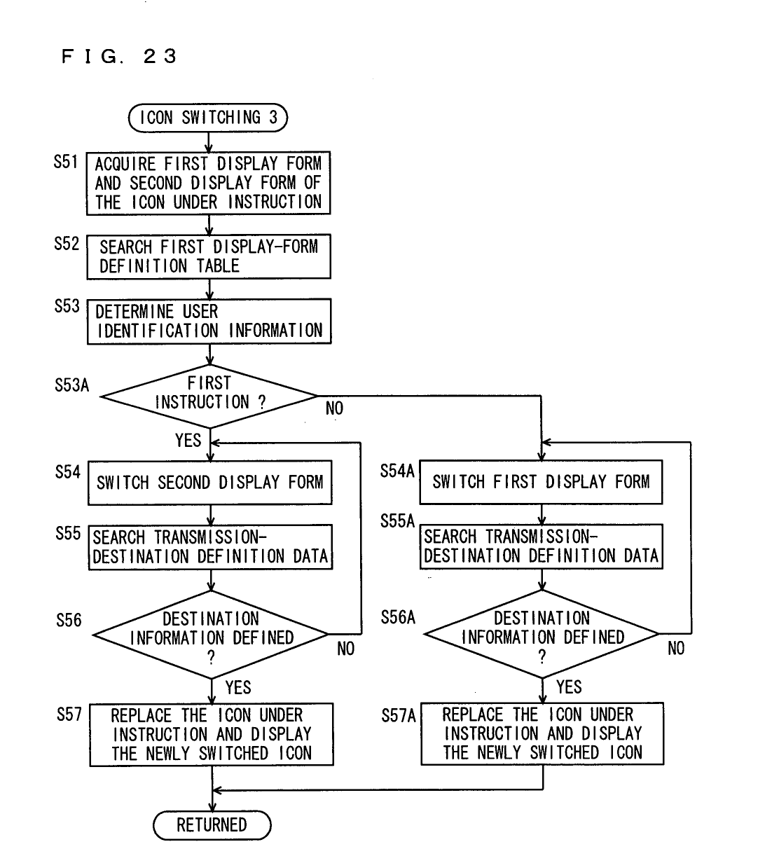

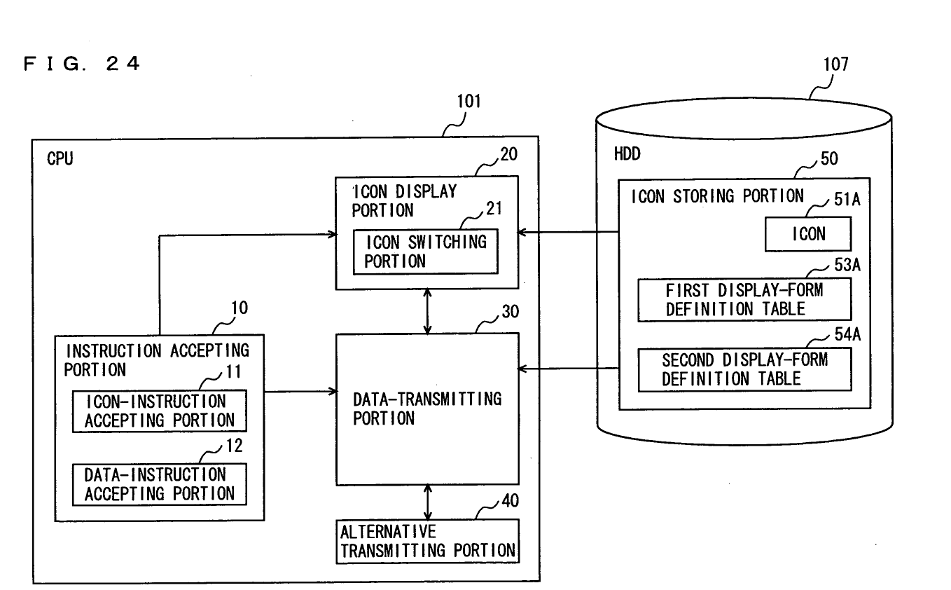

FIG. 22 is a flow chart showing an example of the flow of the operation-receiving processing according to the modified example of the second embodiment. The operation-receiving processing differs from the operation-receiving processing shown in FIG. 19 in step S06B. FIG. 23 is a third flow chart showing an example of the flow of the icon-switching processing. The icon-switching processing is executed in step S06B shown in FIG. 22. Referring to FIG. 23, the icon-switching processing differs from the icon-switching processing shown in FIG. 21, which is the second flow chart, in that step S53A is added between step S53 and step S54, and steps S54A to S57A are added. In step S53A, the CPU 101 judges whether a received instruction of the displayed icon is a first switching instruction. When the instruction is a first switching instruction, the processing proceeds to step S54. When the instruction is a second switching instruction, the processing proceeds to step S54A.

In step S54A, the CPU 101 switches the first display form acquired in step S51. Specifically, since the instruction is made for the icon having the first color (red) as the first display form, the first display form is switched to a color other than the first color. Here the example where the first display form is switched from the first color to the second color, which is next to the first color, will be described.

In the next step S55A, the CPU 101 searches the transmission-destination definition data. As a result of the search, the CPU 101 judges whether the destination information including the piece of user identification information identified by association of the first display form newly switched in step S54A and the first display-form definition table 53 defines the piece of destination information corresponding to the destination name identified by association of the second display form acquired in step S51 and the second display-form definition table 54 (step S56A). When such a piece of destination information is defined in the transmission-destination definition data, the processing proceeds to step S57A. When not, the processing goes back to step S54A.

In step S57A, the CPU 101 displays, instead of the icon for which the instruction is made, the icon having the first display form newly switched in step 54 and having the second display form acquired in step 51. Then, the processing goes back to the operation-receiving processing. That is, the icon for which the instruction is made is replaced, and an icon having a first display form different from the first display form of the replaced icon and having the same second display form as the second display form of the replaced icon is displayed. In other words, only the first display form of the icon for which the instruction is made changes. Here, in place of the icon having the first color (red) as the first display form and having the third design as the second display form, the icon having the second color (blue) as the first display form and having the third design as the second display form is displayed. By looking at the icon having the second color (blue) as the first display form and having the third design as the second display form, the user is able to recognize that the new icon is associated with the e-mail destination information assigned to the user having the user identification information “002”.

Thus, in the modified example of the second embodiment, one of a plurality icons is displayed. When a first switching instruction is accepted, the second display form of the displayed icon is switched. When a second switching instruction is accepted, the first display form of the displayed icon is switched. Thus, only one icon needs to be displayed.

### Third Embodiment

In the second embodiment, the transmission-destination definition data defines a plurality pieces of destination information for each of a plurality of users. In the print system according to a third embodiment, the transmission-destination definition data defines a plurality of print conditions for each of a plurality of image-forming apparatuses. The following description is mainly on differences from the print system according to the second embodiment.

An MFP 200 according to the third embodiment is an image-forming apparatus capable of monochrome printing and incapable of color printing. An MFP 201 is an image-forming apparatus provided with a sheet reverse function, capable of duplex printing, and capable of monochrome printing. An MFP 202 is an image-forming apparatus not provided with a sheet reverse function, capable of single-sided printing, and capable of monochrome printing and color printing.

FIG. 24 is a third functional block diagram showing the outline of the function of the CPU 101, mounted in the PC 100 according to the third embodiment, together with data stored in the HDD 107. The function of the CPU 101 when executing a data-transmitting program will be described here. Referring to FIG. 24, the HDD 107 includes an icon storing portion 50. The icon storing portion 50 includes a plurality of icons 51A having different first display forms and different second display forms, a first display-form definition table 53, and a second display-form definition table 54. The icons 51A, which are stored in the icon storing portion 50, have different first display forms and different second display forms, and thus are identified by respective first display forms and second display forms. The icons 51A, the first display-form definition table 53, and the second display-form definition table 54 are stored in the HDD 107 in advance. The first display-form definition table 53 and the second display-form definition table 54 are generated and amended by user's instructions that are input using the input portion 119A.

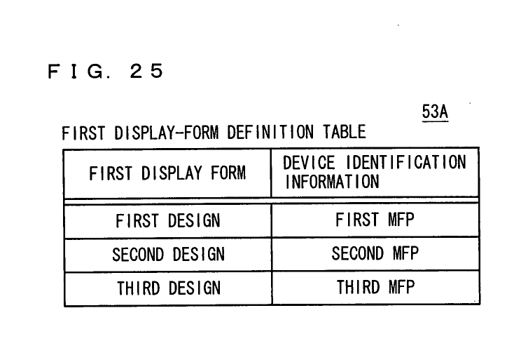

FIG. 25 is a second diagram showing an example of the first display-form definition table. Referring to FIG. 25, a first display-form definition table 53A defines association of the first display forms of the icons and device identification information. The first display form here is the design of an icon. The first display-form definition table 53A associates a first design with the device identification information “first MFP” of the MFP 200, a second design with the device identification information “second MFP” of the MFP 201, and a third design with the device identification information “third MFP” of the MFP 202.

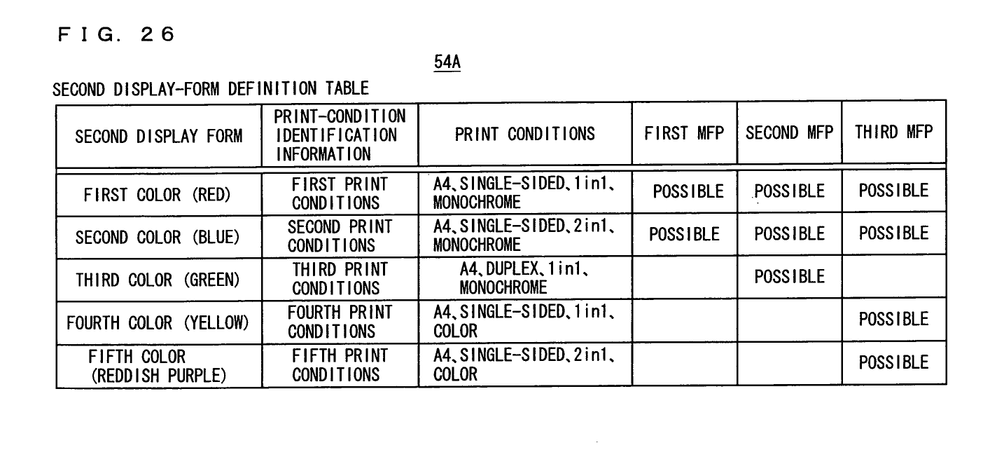

FIG. 26 is a second diagram showing an example of the second display-form definition table. Referring to FIG. 26, the second display-form definition table 54A defines association of the second display forms of the icons and print-condition identification information. The display form here is the color (hue) of an icon. The second display-form definition table associates a first color (red) with first print conditions of the print-condition identification information, a second color (blue) with second print conditions of the print-condition identification information, a third color (green) with third print conditions of the print-condition identification information, a fourth color (yellow) with fourth print conditions of the print-condition identification information, and a fifth color (reddish purple) with fifth print conditions of the print-condition identification information.

The first print conditions and the second print conditions include single-sided printing and monochrome printing, and thus all the MFPs 200, 201, and 202 can execute the first print conditions and the second print conditions. The third print conditions include duplex printing, and thus only the MFP 201, which is capable of duplex printing, can execute the third print conditions. The fourth print conditions and the fifth print conditions include color printing, and thus only the MFP 202, which is capable of color printing, can execute the fourth print conditions and the fifth print conditions.

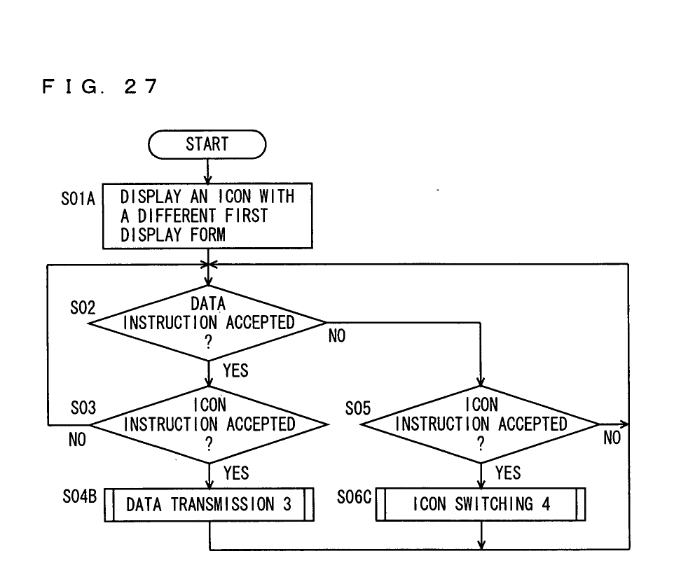

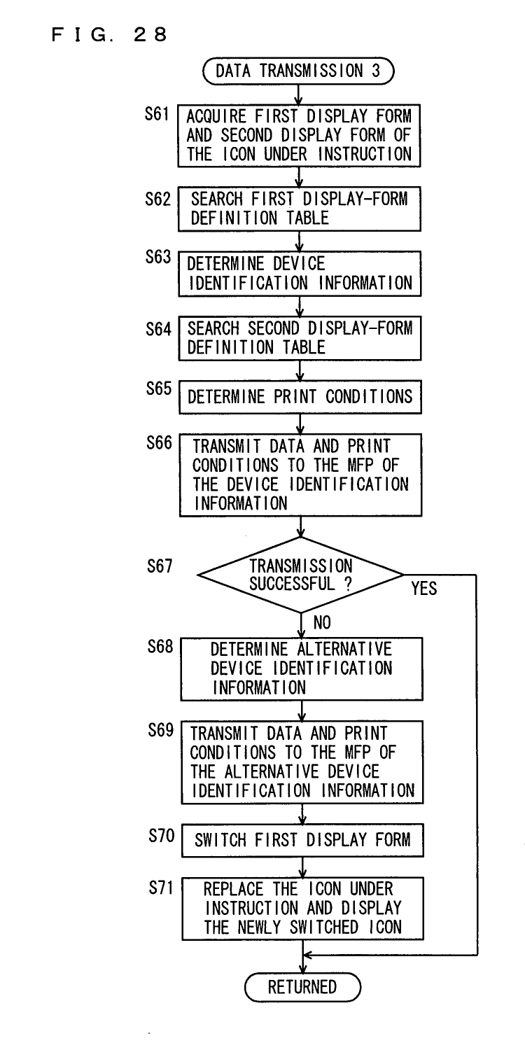

FIG. 27 is a flow chart showing an example of the flow of the operation-receiving processing according to the third embodiment. The operation-receiving processing differs from the operation-receiving processing shown in FIG. 19 in steps S04B and S06C.

FIG. 28 is a third flow chart showing an example of the flow of the data-transmission processing. The data-transmission processing shown in FIG. 28 is executed in step S04B shown in FIG. 27. Referring to FIG. 28, the CPU 101 acquires the first display form and the second display form of the icon for which the instruction is made in step S03 shown in FIG. 27 (step S61). Here the example where the icon for which the instruction is made has the first design as the first display form and the first color (red) as the second display form will be described. In step S62, the CPU 101 searches the first display-form definition table 53A and determines on the device identification information “first MFP”, which is associated with the first design of the first display form (step S63). Next, in step S64, the CPU 101 searches the second display-form definition table 54A and determines on the print-condition identification information “first print conditions”, which are associated with the first color (red) of the second display form (step S65).

In the next step S66, the data for which the instruction is made in step S02 shown in FIG. 27 and the first print conditions determined in step S65 are transmitted to device identification information “first MFP”, which is the MPF 200, determined in step S63.

In the next step S67, the CPU 101 judges whether data transmission is successful. When data transmission is successful, the processing goes back to the operation-receiving processing. When data transmission is not successful, the processing proceeds to step S68. For example, unsuccessful data transmission occurs when the MFP 200 is not active or discontinued because of some failure. In step S68, the CPU 101 determines device identification information (alternative device identification information) different from the device identification information determined in step S63. Here, “second MFP”, which is defined next to the device identification information “first MFP” in the first display-form definition table 53A, is determined as alternative device identification information.

The CPU 101 transmits data for which the instruction is made and the first print conditions determined in step S65 to the MFP 201, which is the alternative device identification information “second MFP” determined in step S68 (step S69). The CPU 101 then refers to the first display-form definition table 53A and switches the first display form to the second design, which corresponds to the alternative device identification information “second MFP” (step S70). Then, the proceeding proceeds to step S71. In step S71, the CPU 101 displays, instead of the icon for which the instruction is made in step S03 shown in FIG. 27, the icon having the second display form acquired in step 61 and having the first display form newly switched in step 70. Then, the processing goes back to the operation-receiving processing. That is, the icon for which the instruction is made is replaced, and an icon having the same second display form as the second display form of the replaced icon and having a first display form different from the first display form of the replaced icon is displayed. In other words, only the first display form of the icon for which the instruction is made changes. Here, in place of the icon having the first design as the first display form and having the first color (red) as the second display form, the icon having the second design as the first display form and having the first color (red) as the second display form is displayed. This enables it to inform the user that the data has been transmitted to device identification information different from the device identification information associated with the icon for which the instruction is made, and inform the user of the device identification information to which the data has been transmitted. In this case, it is possible to alarm the user by displaying the icon in an unusual manner such as with flashing.

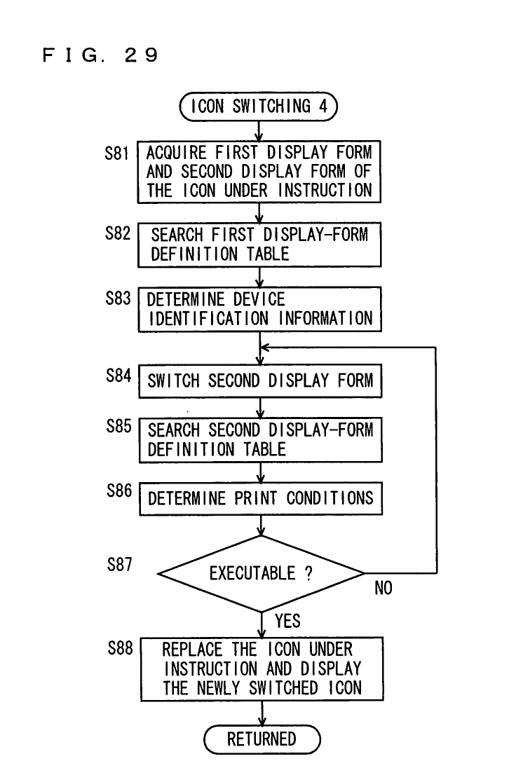

FIG. 29 is a fourth flow chart showing an example of the flow of the icon-switching processing. The icon-switching processing shown in FIG. 29 is executed in step S06C shown in FIG. 27. Referring to FIG. 29, steps S81 to S83 are the same as steps S61 to S63 shown in FIG. 28, and therefore description thereof will not be repeated. In step S84, the CPU 101 switches the second display form acquired in step S81. Specifically, since the instruction is made for the icon having the first color (red) for the second display form, the second display form is switched to a second display form different from the first color (red).

In the next step S85, the CPU 101 searches the second display-form definition table 54A and determines print conditions identified by association of the second display form newly switched in step S84 and the second display-form definition table 54A (step S86). Next, the CPU 101 judges whether the MFP corresponding to the device identification information determined in step S83 can execute the print conditions determined in step S86 (step S87). When the print conditions are executable by the MFP, the processing proceeds to step S88. When the print conditions are not executable by the MFP, the processing goes back to step S84. This is because transmitting unexecutable print conditions to the MFP results in error transmission.

In step S88, the CPU 101 displays, instead of the icon for which the instruction is made, the icon having the first display form acquired in step 81 and having the second display form newly switched in step 84. Then, the processing goes back to the operation-receiving processing. That is, the icon for which the instruction is made is replaced, and an icon having the same first display form as the first display form of the replaced icon and having a second display form different from the second display form of the replaced icon is displayed. In other words, only the second display form of the icon for which the instruction is made changes. Here, in place of the icon having the first design as the first display form and having the first color (red) as the second display form, the icon having the first design as the first display form and having the second color (blue) as the second display form is displayed. By looking at the icon having the first design as the first display form and having the second color (blue) as the second display form, the user is able to recognize that the new icon is for printing the data under the second print conditions using the MFP 200, which corresponds to the device identification information “first MFP”.

<Modified Example>

While in the third embodiment a plurality of icons having different first display forms are displayed, in this modified example a single icon is displayed. In this case, the icon-instruction accepting portion 11 accepts a first switching instruction to switch only the second display form of the displayed icon and a second switching instruction to switch only the first display form of the displayed icon. When the icon-instruction accepting portion 11 accepts a first switching instruction, the icon switching portion 21 replaces the displayed icon and displays an icon having the same first display form as the first display form of the replaced icon and having a second display form different from the second display form of the replaced icon. When the icon-instruction accepting portion 11 accepts a second switching instruction, the icon switching portion 21 replaces the displayed icon and displays an icon having a first display form different from the first display form of the replaced icon and having the same second display form as the second display form of the replaced icon. For example, the first switching instruction is executed by clicking the mouse, and the second switching instruction is executed by clicking the mouse while pressing down the shift key.

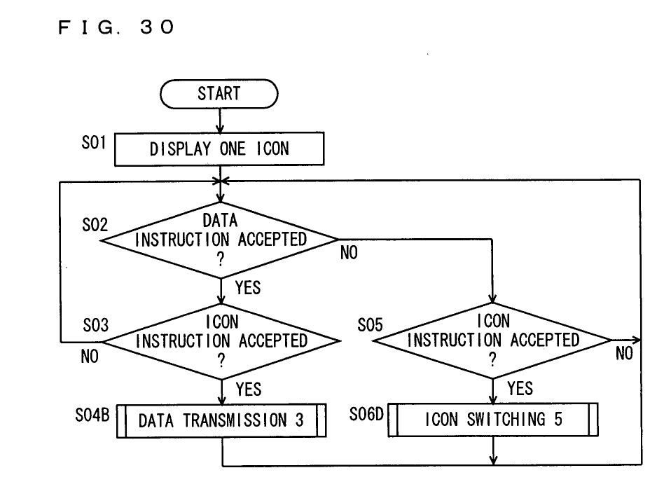

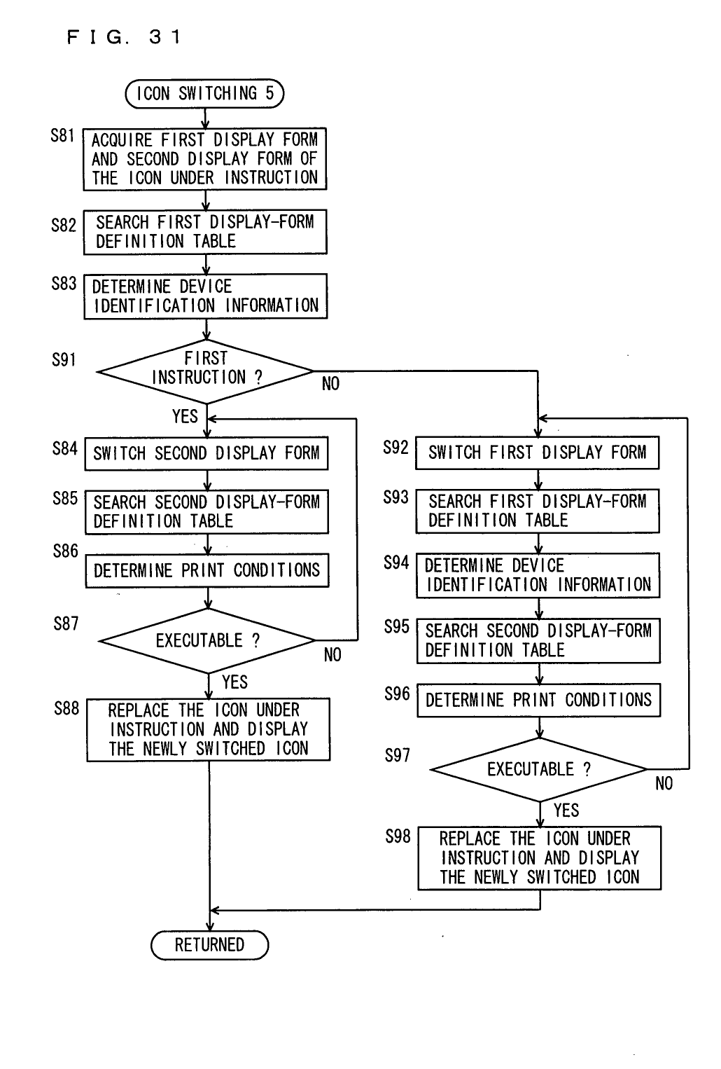

FIG. 30 is a flow chart showing an example of the flow of the operation-receiving processing according to the modified example of the third embodiment. The operation-receiving processing differs from the operation-receiving processing shown in FIG. 27 in step S06D. FIG. 31 is a fifth flow chart showing an example of the flow of the icon-switching processing. The icon-switching processing is executed in step S06D shown in FIG. 30. Referring to FIG. 31, the icon-switching processing differs from the icon-switching processing shown in FIG. 29, which is the fourth flow chart, in that step S91 is added between step S83 and step S84, and steps S92 to S98 are added. In step S91, the CPU 101 judges whether a received instruction of the displayed icon is a first switching instruction. When the instruction is a first switching instruction, the processing proceeds to step S84. When the instruction is a second switching instruction, the processing proceeds to step S92.

In step S92, the CPU 101 switches the first display form acquired in step S81. Specifically, since the instruction is made for the icon having the first design for the first display form, the first display form is switched to a different design. Here the example where the first display form is switched from the first design to the second design, which is next to the first design, will be described.

In the next step S93, the CPU 101 searches the first display-form definition table 53A and determines on the device identification information “second MFP”, which is associated with the second design of the first display form (step S94). Next, in step S95, the CPU 101 searches the second display-form definition table 54A and determines on the print-condition identification information “first conditions”, which are associated with the first color (red) of the second display form (step S96). Next, the CPU 101 judges whether the MFP 201, which corresponds to the device identification information determined in step S94, can execute the print conditions determined in step S96 (step S97). When the print conditions are executable by the MFP 201, the processing proceeds to step S98. When the print conditions are not executable by the MFP 201, the processing goes back to step S92. This is because transmitting unexecutable print conditions to the MFP 201 results in error transmission, and thus it is not necessary to display an icon for transmitting unexecutable print conditions to such a piece of device identification information.

In step S98, the CPU 101 displays, instead of the icon for which the instruction is made, the icon having the second display form acquired in step 81 and having the first display form newly switched in step 92. Then, the processing goes back to the operation-receiving processing. That is, the icon for which the instruction is made is replaced, and an icon having a first display form different from the first display form of the replaced icon and having the same second display form as the second display form of the replaced icon is displayed. In other words, only the first display form of the icon for which the instruction is made changes. Here, in place of the icon having the first design as the first display form and having the first color (red) as the second display form, the icon having the second design as the first display form and having the first color (red) as the second display form is displayed. By looking at the icon having the second design as the first display form and having the first color (red) as the second display form, the user is able to recognize that the new icon is for printing the data under the first print conditions using the MFP 201, which corresponds to the device identification information “second MFP”.

### Fourth Embodiment

In the first to third embodiments, the PC 100 executes the operation-receiving processing. In a print system according to a fourth embodiment, the MFPs 200, 201, and 202 execute the operation-receiving processing, which is executed by the PC 100 in the first to third embodiments. In this case, a CPU 211 of each of the MFPs 200, 201, and 202 executes the processings shown in FIGS. 9 to 11, 19 to 23, and 27 to 31.

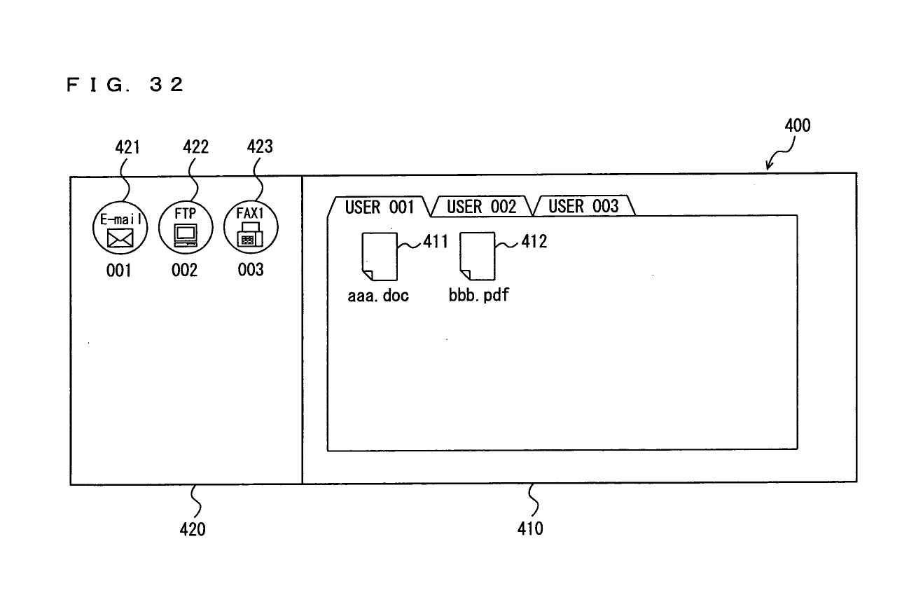

FIG. 32 is a diagram showing an example of the operating screen of a display portion 260A of the MFP 200. The operating screen shown in FIG. 32 corresponds to the screen shown on the display portion 119B of the PC 100 shown in FIG. 18 in the second embodiment. Referring to FIG. 32, an operating screen 400 includes a screen 420 to display icons 421, 422, and 423, and a screen 410 to display pieces of data identification information 411 and 412. The pieces of data identification information 411 and 412 are thumbnails showing a down-sized version of each data. The screen 410 shows the file name “aaa.doc” below the piece of data identification information 411 and the file name “bbb.pdf” below the piece of data identification information 412.

The icon 421 has the first color (red) as the first display form and the third design for the second display form, respectively corresponding to the user identification information “001” and the destination name “E-mail”. The user identification information “001” is displayed below the icon 421. The icon 422 has the second color (blue) as the first display form and the fourth design as the second display form, respectively corresponding to the user identification information “002” and the destination name “FTP”. The user identification information “002” is displayed below the icon 422. The icon 423 has the third color (green) as the first display form and the first design as the second display form, respectively corresponding to the user identification information “003” and the destination name “FAX1”. The user identification information “003” is displayed below the icon 423.

For example, when a user places the user's finger on an area of the touch panel over the piece of data identification information 411, drags it to the icon 421, and takes the finger off the touch panel there, then an electronic mail including the data identified by the piece of data identification information 411 and setting the e-mail address “xx001@aaa.com” as the transmission destination is prepared and transmitted. The same applies to the case where the user places the user's finger on an area of the touch panel over the piece of data identification information 411 and then touches the icon 421 by the finger.

While in the above-described embodiments the difference of the designs and/or colors of the icons is described as an example of the difference of the display forms of the icons, the difference of the display forms of the icons is not limited to design and color; for example, the difference of the shapes of the icons can be employed.

While in the above-described embodiments description has been made of the PC 100 or the MFPs 200, 201, and 202, it will be readily appreciated that the present invention can be taken as a data-transmitting method or a data-transmitting program executed in PC 100 or the MFPs 200, 201, and 202.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data transmitting apparatus comprising:
a transmission-destination definition data storing portion to store transmission-destination definition data defining a plurality pieces of transmission-destination information for transmitting data;
an icon storing portion to store a plurality of icons of which display forms are different each other, said plurality of icons respectively corresponding to said plurality pieces of transmission-destination information defined in said transmission-destination definition data;
a display portion to display one of said plurality of icons;
a transmitting portion to, when an instruction for the displayed icon is made while an instruction for data is made, transmit the data based on a piece of transmission-destination information, corresponding to the icon for which the instruction is made, among said plurality pieces of transmission-destination information; and
a switching-instruction accepting portion to accept a switching instruction to switch the displayed icon with another icon among said plurality of icons.

2. The data transmitting apparatus according to claim 1, wherein each of said plurality pieces of transmission-destination information includes a piece of apparatus identification information for identifying one of a plurality of image-forming apparatuses.

3. The data transmitting apparatus according to claim 1, further comprising an alternative transmitting portion to, when said transmitting portion is unable to transmit the data based on said piece of transmission-destination information corresponding to the icon for which the instruction is made, transmit the data based on another piece of transmission-destination information among said plurality pieces of transmission-destination information instead of said piece of transmission-destination information corresponding to the icon for which the instruction is made, wherein
said display portion includes a display switching portion to display an icon corresponding to said another piece of transmission-destination information instead of the icon for which the instruction is made.

4. The data transmitting apparatus according to claim 1, wherein when an instruction for the displayed icon is made while an instruction for data is not made, said switching-instruction accepting portion accepts input of the switching instruction.

5. A data transmitting apparatus comprising:
a transmission-destination definition data storing portion to store transmission-destination definition data defining a plurality pieces of transmission-destination information for transmitting data, each of said plurality pieces of transmission-destination information corresponding to one of a plurality pieces of user identification information for respectively identifying a plurality of users;
an icon storing portion to store a plurality of icons each having a first display form and a second display form, said first display form of each icon being different from the other first display forms on the basis of said user identification information, said second display form being different from the other second display forms on the basis of said transmission-destination information;
a display portion to display, among the plurality of icons, a plurality of icons having different first display forms and arbitrary second display forms;
a transmitting portion to, when an instruction for one of the plurality of displayed icons is made while an instruction for data is made, transmit the data based on a piece of transmission-destination information, corresponding to the icon for which the instruction is made, among said plurality pieces of transmission-destination information; and
a switching-instruction accepting portion to accept a switching instruction to switch each of the plurality of displayed icons with another icon, wherein
in response to acceptance of the switching instruction, said display portion replaces the icon for which the switching instruction has been accepted and displays another icon having the same first display form as the first display form of the replaced icon and having a different second display form from the second display form of the replaced icon.

6. The data transmitting apparatus according to claim 5, wherein the display portion displays said another icon on condition that a piece of transmission-destination information corresponding to said another icon is defined in said transmission-destination definition data.

7. The data transmitting apparatus according to claim 5, further comprising an alternative transmitting portion to, when said transmitting portion is unable to transmit the data based on said piece of transmission-destination information corresponding to the icon for which the instruction is made, transmit the data based on, among a plurality pieces of transmission-destination information corresponding to said piece of user identification information corresponding to a first display form of the icon for which the instruction is made, another piece of transmission-destination information different from said piece of transmission-destination information corresponding to the icon for which the instruction is made, wherein
said display portion includes a display switching portion to display an icon corresponding to said another piece of transmission-destination information instead of the icon for which the instruction is made.

8. The data transmitting apparatus according to claim 5, wherein when an instruction for one of the displayed icons is made while an instruction for data is not made, said switching-instruction accepting portion accepts input of the switching instruction.

9. A data-transmitting program embodied in a computer readable medium, said data-transmitting program being executed by a computer storing: transmission-destination definition data defining a plurality pieces of transmission-destination information for transmitting data; and a plurality of icons respectively corresponding to said plurality pieces of transmission-destination information defined in said transmission-destination definition data, the plurality of icons of which display forms are different each other, said program causing the computer to execute processing comprising:
displaying one of the plurality of icons:
transmitting, when an instruction for one of the plurality of displayed icons is made while an instruction for data is made, data based on a piece of transmission-destination information, corresponding to the icon for which the instruction is made, among said plurality pieces of transmission-destination information; and
accepting a switching instruction to switch the displayed icon with another icon among the plurality of icons.

10. The data-transmitting program according to claim 9, wherein each of said plurality pieces of transmission-destination information includes a piece of apparatus identification information for identifying one of a plurality of image-forming apparatuses.

11. The data-transmitting program according to claim 9, wherein said processing further comprises:
alternatively transmitting, when transmitting the data based on said piece of transmission-destination information corresponding to the icon for which the instruction is made is impossible, the data based on another piece of transmission-destination information among said plurality pieces of transmission-destination information instead of said piece of transmission-destination information corresponding to the icon for which the instruction is made; and
displaying an icon corresponding to said another piece of transmission-destination information instead of the icon for which the instruction is made.

12. The data-transmitting program according to claim 9, wherein at said accepting step, when an instruction for one of the displayed icon is made while an instruction for data is not made, input of the switching instruction is accepted.

13. A data-transmitting program embodied in a computer readable medium, the data-transmitting program being executed by a computer storing: transmission-destination definition data defining a plurality pieces of transmission-destination information for transmitting data, each of said plurality pieces of transmission-destination information corresponding to one of a plurality pieces of user identification information for respectively identifying a plurality of users; and a plurality of icons each having a first display form and a second display form, said first display form of each icon being different from the other first display forms on the basis of said user identification information, said second display form being different from the other second display forms on the basis of said transmission-destination information, said program causing the computer to execute processing comprising;
displaying, among the plurality of icons, a plurality of icons having different first display forms and arbitrary second display forms;
transmitting, when an instruction for one of the plurality of displayed icons is made while an instruction for data is made, the data based on a piece of transmission-destination information, corresponding to the icon for which the instruction is made, among said plurality pieces of transmission-destination information;
accepting a switching instruction to switch each of the plurality of displayed icons with another icon; and
replacing, in response to acceptance of the switching instruction, the icon for which the switching instruction has been accepted and displaying another icon having the same first display form as the first display form of the replaced icon and having a different second display form from the second display form of the replaced icon.

14. The data-transmitting program according to claim 13, wherein at said replacing and displaying step, said another icon is displayed on condition that a piece of transmission-destination information corresponding to said another icon is defined in said transmission-destination definition data.

15. The data-transmitting program according to claim 13, further wherein said processing comprises:
transmitting, when transmitting the data based on said piece of transmission-destination information corresponding to the icon for which the instruction is made is impossible, the data based on, among a plurality pieces of transmission-destination information corresponding to said piece of user identification information corresponding to a first display form of the icon for which the instruction is made, another piece of transmission-destination information different from said piece of transmission-destination information corresponding to the icon for which the instruction is made; and
displaying an icon corresponding to said another piece of transmission-destination information instead of the icon for which the instruction is made.

16. The data-transmitting program according to claim 13, wherein at said accepting step, when an instruction for one of the displayed icons is made while an instruction for data is not made, input of the switching instruction is accepted.

17. A data transmission method executed by a computer storing: transmission-destination definition data defining a plurality pieces of transmission-destination information for transmitting data; and a plurality of icons respectively corresponding to said plurality pieces of transmission-destination information defined in said transmission-destination definition data, the plurality of icons of which display forms are different each other, said data transmission method comprising:
displaying one of the plurality of icons;
transmitting, when an instruction for one of the plurality of displayed icons is made while an instruction for data is made, data based on a piece of transmission-destination information, corresponding to the icon for which the instruction is made, among said plurality pieces of transmission-destination information; and
accepting a switching instruction to switch the displayed icon with another icon among the plurality of icons.

18. A data-transmitting method executed by a computer storing: transmission-destination definition data defining a plurality pieces of transmission-destination information for transmitting data, each of said plurality pieces of transmission-destination information corresponding to one of a plurality pieces of user identification information for respectively identifying a plurality of users; and a plurality of icons each having a first display form and a second display form, said first display form of each icon being different from the other first display forms on the basis of said user identification information, said second display form being different from the other second display forms on the basis of said transmission-destination information, said data transmission method comprising:
displaying, among the plurality of icons, a plurality of icons having different first display forms and arbitrary second display forms;
transmitting, when an instruction for one of the plurality of displayed icons is made while an instruction for data is made, the data based on a piece of transmission-destination information, corresponding to the icon for which the instruction is made, among said plurality pieces of transmission-destination information;
accepting a switching instruction to switch each of the plurality of displayed icons with another icon; and
replacing, in response to acceptance of the switching instruction, the icon for which the switching instruction has been accepted and displaying another icon having the same first display form as the first display form of the replaced icon and having a different second display form from the second display form of the replaced icon.
